(19) United States
(12) Patent Application Publication
(10) Pub. No.: US 2025/0036131 A1
(43) Pub. Date: Jan. 30, 2025

(54) REMOTE OPERATOR SAFETY STATION

(71) Applicant: Robotic Research OpCo, LLC, Clarksburg, MS (US)

(72) Inventors: Alberto Daniel Lacaze, Potomac, MD (US); Rashmi Patel, Gaithersburg, MD (US); Joseph Putney, Waterford, CT (US); Karl Nicholas Murphy, Cocoa Beach, FL (US)

(21) Appl. No.: 18/707,082

(22) PCT Filed: Nov. 3, 2022
(86) PCT No.: PCT/US2022/048872

§ 371 Date: May 2, 2024

Related U.S. Application Data
(60) Provisional application No. 63/275,404, filed on Nov. 3, 2021.

(51) Int. Cl. G05D 1/227; B60W 10/04; B60W 10/18; B60W 10/20; B60W 60/00; G05D 1/222

(52) U.S. Cl. CPC G05D 1/2279; B60W 10/04; B60W 10/18; B60W 10/20; B60W 60/0015; G05D 1/222; B60W 2520/06; B60W 2520/10; B60W 2556/45; B60W 2710/18; B60W 2710/20; B60W 2720/106

(57) ABSTRACT

Systems and methods for remote control of one or more autonomous vehicles by a human operator are provided.

### CROSS-REFERENCE TO RELATED APPLICATIONS

The present application claims benefit and priority to, and is a non-provisional of, U.S. Provisional Patent Application No. 63/275,404 filed on Nov. 3, 2021 and titled “REMOTE OPERATOR SAFETY STATION”, the contents of which are hereby incorporated by reference herein.

### FIELD

The present disclosure relates generally to autonomous vehicles, and more particularly, to discrete remote control of an autonomous vehicle by a human operator to ensure safe operation.

### BACKGROUND

Autonomous vehicles use sensors to detect their surroundings and determine how and where to drive. In many applications, the technology is not fully developed or vetted, requiring an onboard human operator to monitor the autonomous vehicle and to take control when necessary. As autonomous vehicle technology advances, the need for constant human monitoring, control, and supervision may be reduced (e.g., only required for certain times, locations, and/or operating conditions), and thus allow monitoring and/or control by a human operator remotely.

### SUMMARY

As autonomous vehicle (autonomous vehicle) technology advances, constant human supervision may not be necessary, thereby allowing a human supervisor (also referred to herein as a human operator, safety operator, or steward) to be located remote from the autonomous vehicle rather than physically within the autonomous vehicle. Moreover, as less of their time is required per vehicle, the human supervisor will be able to monitor multiple autonomous vehicles at the same time, e.g., intervening only when a special case arises. Embodiments of the disclosed subject matter thus provide a remote safety station with a set of alternative control modalities (e.g., partial and/or upper-hierarchy commands and/or discrete options) that allow a human supervisor (or group of supervisors) to take full or partial control of an autonomous vehicle, e.g., one from a plurality of autonomous vehicles (e.g., fleet deployed to the same location (e.g., parking lot) or different locations). In some embodiments, the remote safety station can employ its own automation (e.g., via its own autonomous operation stack, which, in some embodiments, may be more sophisticated than the autonomous operation stack controlling each autonomous vehicle), for example, to supplement or replace manual operation by the remote human supervisor.

### BRIEF DESCRIPTION OF THE DRAWINGS

Where applicable, some elements may be simplified or otherwise not illustrated in order to assist in the illustration and description of underlying features. For example, in some figures, some components have been illustrated using a partial or cutaway view in order to illustrate internal interaction of components. Throughout the figures, like reference numerals denote like elements. An understanding of embodiments described herein and many of the attendant advantages thereof may be readily obtained by reference to the following detailed description when considered with the accompanying drawings, wherein:

FIG. 1 is a block diagram is a system according to some embodiments;

FIG. 2A-E are diagrams of a system according to some embodiments;

FIG. 3 is a flow diagram of a method according to some embodiments;

FIG. 4 is a block diagram of an apparatus according to some embodiments;

FIG. 5A-D are diagrams of a system according to some embodiments;

FIG. 6A-B are diagrams of a user interface according to some embodiments;

FIG. 7A-B are diagrams of a user interface according to some embodiments;

FIG. 8A-B are diagrams of a user interface according to some embodiments;

FIG. 9 is a flow diagram of a method according to some embodiments; and

FIG. 10 is a block diagram of an apparatus according to some embodiments.

### DETAILED DESCRIPTION

### I. Introduction

As autonomous vehicle (autonomous vehicle) technology advances, constant human supervision may not be necessary, thereby allowing a human supervisor (also referred to herein as a human operator, safety operator, or steward) to be located remote from the autonomous vehicle rather than physically within the autonomous vehicle. Moreover, as less of their time is required per vehicle, the human supervisor will be able to monitor multiple autonomous vehicles at the same time, e.g., intervening only when a special case (referred herein as an “exception condition”) arises.

Some control stations that are designed to control a remote vehicle beyond dispatching are focused heavily on standard tele-operation. These control stations tend to provide low-level, extensive control, with little in the way of automation, human-machine interface (HMI) improvements, or high-level decision-making. As result, such control stations typically require a human operator to maintain focus for long periods of time, often on visually-intensive objects such as video streams or status alerts. This high level of information processing can be exhausting for the human operator, thereby resulting in operator fatigue that may compromise the safe operation of an autonomous vehicle. These control stations can suffer from the flaws of (i) being vehicle-centric, (ii) providing excessive controls/feedback, which may not be contextually significant, (iii) providing a human-computer interface that lacks goal-oriented command and control; and (iv) is generally non-extensible.

Vehicle-Centric: Current control stations are largely vehicle-centric, where status information and commands are specific to one vehicle at a time. This can constrain a single operator to control one asset from a single station and thereby prevent the type of force multiplication required for more complicated operations.

Controls/Feedback are excessive and not contextually significant: Existing operator control units (OCUs) can overload the operator with excessive information and too many controls to make quick mission-level decisions. This can also impair the operator's ability to quickly or accurately understand the mission state, both at the global level and the situational awareness level. Furthermore, the status information and controls are not contextually applicable to the task being executed.

Human-Computer Interface (HCI) lacks goal-oriented command and control: In existing systems, HCIs do not have a modular architecture to manage multiple, concurrent goals, nor do they have efficient mechanisms for modifying, displaying, and/or utilizing ontologies of mission types, tasks, and/or plans. Rather, the goals and/or ontologies are often hard-coded into the system, and thus difficult to modify without changing the software. As a result, these HCIs are brittle to rapidly changing environments and conditions.

Non-Extensible: A major weakness of existing control stations is that they do not provide the ability to modify their functionality after they've been designed. This limitation results in a piece of software that cannot be adapted to unforeseen scenarios, or modified to fit the needs of a particular operator and/or application of the autonomous vehicle.

Embodiments of the disclosed subject matter may address one or more of the above-noted problems and disadvantages, among other things.

Thus, in one or more embodiments of the disclosed subject matter, a remote operator safety station is provided to allow one or more human operators to remotely monitor a plurality or a fleet of autonomous vehicles (e.g., fleet deployed to the same location (e.g., parking lot) or different locations; e.g., of vehicles guided by local/individual Artificial Intelligence (AI) modules and/or rule sets), apply a remote/centralized AI module/rules set to incoming exception data to filter, triage, and/or direct (e.g., to the most qualified remote operators), and to intervene when an autonomous vehicle encounters a special case (e.g., an exception condition or an emergency condition).

The remote operator safety station can be configured to allow the human operator, who is located outside of the autonomous vehicle at a different location, to temporarily, fully, partially, and/or periodically control the autonomous vehicle (e.g., to tele-operate the autonomous vehicle). Alternatively or additionally, the remote operator safety station can be configured to allow the human operator to provide discrete command instructions, for example, permission for the autonomous vehicle to perform a pre-defined action or a group of actions (e.g., individual commands/actions) that the autonomous operation stack (e.g., on-board AI logic) of the autonomous vehicle would otherwise prohibit, e.g., for execution via autonomous action. In some embodiments, the remote operator safety station can employ its own automation (e.g., via its own autonomous operation stack/remote AI logic, which, in some embodiments, may be more sophisticated than the autonomous operation stack controlling each autonomous vehicle), for example, to supplement or replace manual operation by the remote human supervisor.

In some embodiments, the remote operator safety station can be configured to allow intervention primarily or only when the autonomous vehicle experiences an exception condition (e.g., deviation from normal operation, sensor failure, unexpected obstacle, etc.) or emergency condition. In some embodiments, the autonomous vehicle operates autonomously until the exception or emergency condition is detected (e.g., by the autonomous vehicle itself and/or by the monitoring remote safety station), after which the autonomous vehicle can cease or pause autonomous operation and request instructions (e.g., permission to continue or deviate) from and/or remote control (e.g., tele-operation) by the remote safety station. For example, if a primary sensor was damaged, the autonomous vehicle may be able to safely stop, but otherwise require the human supervisor, via the remote safety station, to drive the autonomous vehicle to a repair location or maintenance facility. In another example, the autonomous vehicle may encounter an unexpected obstacle blocking its path, and the autonomous vehicle may require the human supervisor, via the remote safety station, to provide permission and/or discrete instructions to deviate from the normal path.

In some embodiments, the remote operator safety station can provide a human operator with a set of control modalities (e.g., partial and/or upper-hierarchy commands and/or discrete options), which can intertwine full autonomy by the autonomous vehicle with partial or high-level tele-operation and/or other remote-control methods. In some embodiments, the human operator can choose to use one or more of these capabilities to at least partly control or maneuver (or decide not to move) the autonomous vehicle. In some embodiments, the control modalities can comprise one or more partial (e.g., allowing for some control by the autonomous vehicle) or upper-hierarchy commands or station operations including: (a) ignore an obstacle; (b) ignore a sensor; (c) forget an obstacle; (d) steer with autonomous speed control; (e) manual speed control with autonomous steering; (f) follow a parallel path; (g) single avoidance permission; (h) path option selection; (i) U-turn or K-turn selection; (j) lane following; (k) proceed with dead-man pressed; (l) speed-protected tele-operation; (m) offset tele-operation with Obstacle Avoidance (OA); (n) offset tele-operation without OA; (o) reduce speed limit; (p) store modifications; (q) follow vehicle; (r) follow another autonomous vehicle; (s) follow pedestrian; (t) follow a route to location and then stop until operator is available; (u) change control to different operator; (v) shared control where one operator controls steering and anther controls speed; (w) remote autonomous control; (x) stop at feature; (y) backup to feature; (z) set group speed; (aa) verify signal information; (ab) go to shelter; (ac) panic messaging; (ad) restart sensor or reboot; or any combination of the foregoing.

In some embodiments, the partial and/or upper-hierarchy commands (e.g., “discrete options” for controlling the autonomous vehicle) may comprise command words, phrases, and/or action descriptions that are related to (e.g., a stored data relationship) and/or that define a plurality of lower-hierarchy or individual commands. The lower-hierarchy or individual commands may comprise, for example, a set of specific autonomous vehicle actions, settings, and/or routines that are cooperatively executed to achieve a goal and/or objective. According to some embodiments, the partial and/or upper-hierarchy commands may permit a remote operator to provide simple, high-level instructions to a remote autonomous vehicle to, e.g., permit the autonomous vehicle to overcome an obstacle and/or issue that was identified as an autonomous logic exception, without the remote operator needing to issue (or even know) the respective lower-hierarchy or individual commands that are invoked by the partial and/or upper-hierarchy commands. In such a manner, for example, a remote operator may more easily help a large number of autonomous vehicles overcome exceptions while not being require to issue individual/lower-hierarchy commands to each vehicle and/or may not require a level of training that would otherwise be required to know/execute the individual/lower-hierarchy commands. Some examples of partial and/or upper-hierarchy commands and their respective lower-hierarchy or individual commands and/or actions are listed below.

Ignore obstacle: In this modality, the operator may instruct the autonomous vehicle to ignore a detected obstacle that the operator deems harmless (e.g., an empty paper bag). The autonomous vehicle may need to have human supervision to continue operating until it is past the detected obstacle.

Ignore sensor. In this modality, the operator may instruct the autonomous vehicle to ignore an aberrant sensor, for example, for a period of time. This may be useful when a sensor is not working properly (e.g., a bug on a window case). The autonomous vehicle may need to have human supervision to continue operating without the sensor redundancy, and/or a human may need to make the determination to proceed without the sensor given the safety releases for a particular application.

Forget obstacles: In this modality, the operator may instruct the autonomous vehicle to forget obstacles that it has detected in the past. For example, if a cat hid under the autonomous vehicle, the autonomous vehicle may not have sensor modalities that allow it to detect if the cat is still under the autonomous vehicle. The operator may thus instruct the autonomous vehicle to simply forget that obstacle is there and proceed to slowly move the autonomous vehicle until the operator is convinced that there is no risk to the animal.

Steer with autonomous speed control: The operator may choose to drive in an area where the autonomous vehicle is not usually allowed to drive; however, the operator may allow the autonomous vehicle to set the speed at which it travels. Alternatively or additionally, in some embodiments, the operator can allow the autonomous vehicle to use its obstacle avoidance system to stop the autonomous vehicle if there is an obstacle (e.g., pedestrian) and/or if the obstacle avoidance system otherwise detects a problem with the driving of the autonomous vehicle by the human operator via the remote safety station. In contrast to tele-operation (e.g., where the human operator completely and remotely controls the operation of the autonomous vehicle), the autonomous vehicle's autonomous systems and the remote operator share control over safe operation of the autonomous vehicle.

Manual speed control with autonomous steering: In this modality, the operator controls the speed while the autonomous vehicle controls the steering. For example, this modality may be useful if the operations require the autonomous vehicle to cross intersections for which the sensor suite of the autonomous vehicle cannot warrantee safety (e.g., if the sensors cannot see far enough or are blocked). The autonomous vehicle can continue to steer autonomously while having the operator dictate speed.

Follow parallel path: In this modality, the operator can instruct the autonomous vehicle to follow a parallel path to what the autonomous vehicle would normally traverse (e.g., as determined by a route planning module of the autonomous vehicle or a predetermined set route). In some embodiments, the operator may instruct the autonomous vehicle to slowly drive on the shoulder or even off-road, for example, to accommodate a physical malfunction of the autonomous vehicle (e.g., flat tire).

Single avoidance permission: In this modality, the operator can instruct the autonomous vehicle to deviate from its previously determined path (e.g., as determined by a route planning module of the autonomous vehicle or a predetermined set route) only for a location, distance, or time (e.g., a special location, distance, or time or as otherwise set by the operator) and then return to driving on the remainder of the previously determined path.

Path option selection: In this modality, when an obstacle is encountered, the autonomous vehicle can ask the operator to choose from a variety of available trajectory selections. For example, if a traversable obstacle (e.g., bag) is on the road, the autonomous vehicle may provide the remote safety station with a number of choices (e.g., (1) drive over the bag, (2) drive to the left of the bag, (3) drive to the right of the bag, (4) drive over straddling the bag, etc.) from which the operator selects, rather than (or in addition to) the operator taking control to drive the autonomous vehicle.

U-turn/K-turn selection: In this modality, the operator can instruct the autonomous vehicle to change directions. The autonomous vehicle may generate a set of new turns that were not previously part of its behavior repertoire. The operator may choose from the generated set, one or more maneuvers that may be preferred.

Lane following: In this modality, the remote safety station can process imagery provided by the autonomous vehicle (e.g., via a camera or other optical sensor mounted on or in the autonomous vehicle) to automatically detect the road (or lanes therein) and present the imagery and/or detected lanes to the operator (e.g., via a monitor or other display of the remote safety station). This may be useful in embodiments where the autonomous vehicle may not otherwise be capable of performing lane following (e.g., detection of a lane and subsequently driving along the detected lane).

Proceed with dead-man pressed: In this modality, the remote safety station is configured to require continuous supervision and confirmation from the human operator. For example, the remote safety station can allow the autonomous vehicle to continue driving only when the remote dead-man (e.g., dead-man switch or another device) is actuated (e.g., pressed) by the human operator. This may be useful in embodiments where the autonomous vehicle is operating under adverse weather conditions, for example, where the sensors of the autonomous vehicle are still functional but below a level that allows the autonomous vehicle to operate without supervision. In such conditions, the autonomous vehicle may be programmed only to operate if the dead-man switch is actuated by the human operator. Alternatively or additionally, the remote safety station can be provided with eye-tracking or other operator monitoring features, and the autonomous vehicle may be programmed only to operate if the eye-tracking or operator monitoring features indicate engagement by the human operator (e.g., the human operator is awake and watching autonomous vehicle operation via a display). This modality can thus provide positive feedback that the operator is paying attention to what the autonomous vehicle is doing, e.g., to ensure safe operation.

Speed protected tele-operation: In this modality, the remote operator can gain control of the autonomous vehicle; however, the autonomous operation system of the autonomous vehicle still performs object detection, classification of objects, tracking of objects, and/or prediction of objects. The human operator can choose a trajectory to be followed by the autonomous vehicle; however, the autonomous vehicle can adjust the speed (e.g., including stopping) in order to avoid moving or stationary obstacles detected by the autonomous vehicle. In some embodiments, this can provide a safer method of remote driving by requiring both the human operator and the autonomous vehicle to determine a path that is free of obstacles.

Offset tele-operation with OA: In this modality, the human operator can drive the autonomous vehicle via a user interface of the remote safety station. For example, in some embodiments, the user interface can include a setup with steering (e.g., steering wheel or joystick), braking (e.g., brake pedal), and/or acceleration (e.g., accelerator pedal) inputs that a human operator can manually actuate to provide drive control commands to a selected autonomous vehicle. In some embodiments, the steering commands from the human operator can be interpreted (e.g., by the remote safety station itself or by the autonomous vehicle receiving the commands) as cross offsets from the lane rather than implicit steering angles (as may normally be the case with by a steering wheel interface). This can allow the human operator to more easily drive the autonomous vehicle following offsets from the trajectories preprogrammed.

Offset tele-operation without OA: Similar to the above, but without OA. In this case, the movement of the autonomous vehicle may rely only on the remote operator's sensing capabilities.

Reduce speed limit: In this modality, the human operator can reduce the operation speed limit for a particular location or duration. In some embodiments, the human operator can set an alternative (e.g., lower than) to the max speed normally allowed by the autonomous operation system of the autonomous vehicle for that location.

Store modifications: In this modality, after the human operator has taken control of the autonomous vehicle and created an alternative route (referred to herein as an “updated route”), the autonomous vehicle can add the alternative route to its previously-stored repertoire of routes for use by the autonomous vehicle (e.g., as a new lane). In some embodiments, the instruction to add the alternative route may originate from the remote safety station, or the autonomous vehicle may automatically add the alternative route. For example, this functionality can be used to store new trajectories needed to avoid construction areas that define a new traffic pattern.

Follow vehicle: In this modality, the human operator can select a vehicle based on images from cameras or data from other sensors of the autonomous vehicle, and can instruct the autonomous vehicle to automatically follow the selected vehicle (which may be another autonomous vehicle or a human-operated vehicle). In some embodiments, once the lead vehicle is chosen by the human operator, the remote safety station can be configured to process the images (or other sensor data) from the autonomous vehicle to track the lead vehicle and to automatically generate and send tele-operation commands to the autonomous vehicle. In some embodiments, the human operator can set a constant speed for the following by the autonomous vehicle and/or manually control the speed of the autonomous vehicle as it follows the lead vehicle.

Follow other autonomous vehicle: In this modality, a lead autonomous vehicle (e.g., selected by the human operator or predetermined) can send information regarding waypoints (e.g., location of its current position and/or planned positions) to the remote safety station. Based on the received information, the remote safety station can determine control commands for another autonomous vehicle to follow the lead autonomous vehicle. In some embodiments, the remote safety station can then automatically send the control commands to the another autonomous vehicle to effect the following (e.g., by the remote safety station sending a path to a waypoint for the another autonomous vehicle to autonomously follow, or by the remote safety station autonomously teleoperating the another autonomous vehicle to follow the lead autonomous vehicle).

Follow pedestrian: In this modality, the human operator can select a pedestrian based on images from cameras or data from other sensors of the autonomous vehicle, and can instruct the autonomous vehicle to automatically follow the selected pedestrian. In some embodiments, once the pedestrian is chosen by the human operator, the remote safety station can be configured to process the images (or other sensor data) from the autonomous vehicle to track the pedestrian and to automatically generate and send tele-operation commands to the autonomous vehicle. In some embodiments, the human operator can set a constant speed for the following by the autonomous vehicle and/or manually control the speed of the autonomous vehicle as it follows the pedestrian.

Follow route to location and then stop until operator is available: In this modality, the human operator can instruct the autonomous vehicle to follow a route (e.g., trajectory or path to a particular location), and, after the route is completed, to then stop until the human operator resumes the mission or assigns a new one.

Change control to different operator. In this modality, the remote safety station is configured to allow control of an autonomous vehicle to be switched between human operators (e.g., a first and second operators at different terminals of the same safety station, which terminals may be at a same location or different location; or between operators of different safety station operatively connected together (e.g., via a network)). If the autonomous vehicle is being teleoperated by a first human operator, the remote safety station can be configured to allow the switch to a second human operator only if the new operator is online. In some embodiments, the remote safety station is configured to make a switch to the second human operator with a command that is compatible with the current first operator's commands (e.g., similar steering and speed). Alternatively or additionally, in some embodiments, the remote safety station can employ force feedback to the user interface of each human operator, such that the inputted commands from the first operator move the controller of the second operator, and vice versa, so as to provide control matching until the switch is fully complete. In some embodiments, the remote safety station can be configured to provide a verification (e.g., visual, audible, or tactile) to the first operator once the second operator is online and/or the transfer has been successfully completed.

Shared Control: In this modality, the remote safety station can be configured to allow one human operator to control steering while another human operator controls speed, or to allow other variations of shared control.

Remote Autonomous Control: In this modality, sensor data (e.g., raw data or processed data by the autonomous vehicle, for example, to detect obstacles) is sent from the autonomous vehicle to the remote safety station, and the remote safety station is configured to process the sensor data and to automatically compute (e.g., without human operator input) driving commands for the autonomous vehicle. The remote safety station can then send these commands to the autonomous vehicle, for example, in the form of tele-operation commands (e.g., steering, acceleration, or braking commands) or as a path for the autonomous vehicle to follow (e.g., a set of waypoints).

Stop at feature: In this modality, the remote safety station can be configured to allow the human operator to select a feature (e.g., wall, line on the road, etc.) on an image (e.g., taken by a camera on the autonomous vehicle or compiled based on sensor data from the autonomous vehicle) and then command the autonomous vehicle to move forward until the feature is reached (e.g., until the autonomous vehicle contacts the selected feature, or until a distance between the autonomous vehicle and the feature is within a predetermined range (e.g., offset from that feature)). In some embodiments, feedback regarding location of the autonomous vehicle with respect to the selected feature can be processed by the remote safety station (e.g., based on data from the autonomous vehicle) and the remote safety station can control the autonomous vehicle to stop when the feature is reached. Alternatively or additionally, feedback regarding location of the autonomous vehicle with respect to the selected location can be processed by the autonomous vehicle, and the autonomous vehicle can automatically stop (e.g., without receiving a separate command from the remote safety station) when the feature is reached. For example, the autonomous vehicle can use its onboard sensor suite (e.g., cameras, ultrasonic sensors, radio detection and ranging (RADAR), light detection and ranging (LIDAR), etc.) to measure the distances to the feature selected by the human operator.

Backup to feature: In this modality, the remote safety station can be configured to allow the human operator to select a feature (e.g., wall, line on the road, etc.) on an image (e.g., taken by a camera on the autonomous vehicle or compiled based on sensor data from the autonomous vehicle) and then command the autonomous vehicle to move backward (reverse) until the feature is reached (e.g., until the autonomous vehicle contacts the selected feature, or until a distance between the autonomous vehicle and the feature is within a predetermined range (e.g., offset from that feature)). In some embodiments, feedback regarding location of the autonomous vehicle with respect to the selected feature can be processed by the remote safety station (e.g., based on data from the autonomous vehicle) and the remote safety station can control the autonomous vehicle to stop when the feature is reached. Alternatively or additionally, feedback regarding location of the autonomous vehicle with respect to the selected location can be processed by the autonomous vehicle, and the autonomous vehicle can automatically stop (e.g., without receiving a separate command from the remote safety station) when the feature is reached. For example, the autonomous vehicle can use its onboard sensor suite (e.g., cameras, ultrasonic sensors, RADAR, LIDAR, etc.) to measure the distances to the feature selected by the human operator.

Set group speed: In this modality, the remote safety station can be configured to allow an operator to set a current speed, a maximum speed, and/or a speed percentage (e.g., reduce speeds 20% in anticipation of inclement weather) for a group of multiple autonomous vehicles simultaneously. In some embodiments, the group of autonomous vehicles can be selected on an ad hoc basis (e.g., by an operator manually adding to autonomous vehicles from a fleet to a group set list in the remote safety station). Alternatively or additionally, in some embodiments, autonomous vehicles for the group can be selected manually or automatically by the remote safety station based on autonomous vehicle characteristics, such as vehicle class, vehicle function, georeferencing areas of operation, or any combination thereof.

Verify signal information: In this modality, the autonomous vehicle can be configured to request, and the remote safety station can be configured to provide to the autonomous vehicle, verification of integrity of communication infrastructure (e.g., that communications between the remote safety station and the autonomous vehicle are not defective). Alternatively or additionally, the remote safety station can be configured to provide an indication to the human operator of communication status, for example, via a visible light, audible alarm, or tactile feedback (e.g., vibration) to indicate compliant communications or, alternatively, to indicate a problem in communications. For example, the autonomous vehicle may request from the human operator a verification of signal or light status in the case of communication failure (e.g., autonomous vehicle to communication infrastructure failure), so as to provide a measure of redundancy to autonomous vehicle operations.

Go to shelter. In this modality, the remote safety station can be configured to allow a human operator to send one or more autonomous vehicles to one or more predetermined shelter locations, charging locations, and/or safe areas.

Panic messaging: In this modality, the autonomous vehicle can be configured to allow a passenger within the autonomous vehicle to provide a panic message to the human operator. In some embodiments, the autonomous vehicle can send the panic message over the communication network to the remote safety station, which can be configured to prioritize the panic message for review by the human operator (e.g., by flashing on a display screen and/or by routing to the terminal of a human operator with capacity to immediately address the panic message). For example, the panic message can be a medical emergency, a vehicle emergency, a physical altercation or other law enforcement scenario (e.g., a robbery), a fire emergency, or any other type of emergency. In response to the panic message, the human operator can choose to respond to the message (e.g., via audible or visual communication with the interior of the autonomous vehicle), ignore the message (e.g., without taking further action, for example, if the panic message was a false alarm), alter operation of the autonomous vehicle (e.g., by stopping or re-routing the vehicle), by sending a request for intervention (e.g., to summon police, fire department, or towing), or any combination of the foregoing.

Restart sensor or reboot: In this modality, the remote safety station can be configured to allow an operator to restart a sensor, a subcomponent of the autonomous operation system (also referred to herein as autonomous vehicle stack, e.g., (i) the sensor suite, (ii) control system (e.g., for sensor processing, trajectory planning, and obstacle avoidance), and (iii) the drive-by-wire kit that allows the autonomous vehicle to autonomously operate) of the autonomous vehicle, or all of the autonomous operation system of the autonomous vehicle.

### II. Autonomous Driving System with Remote Operator Safety Station

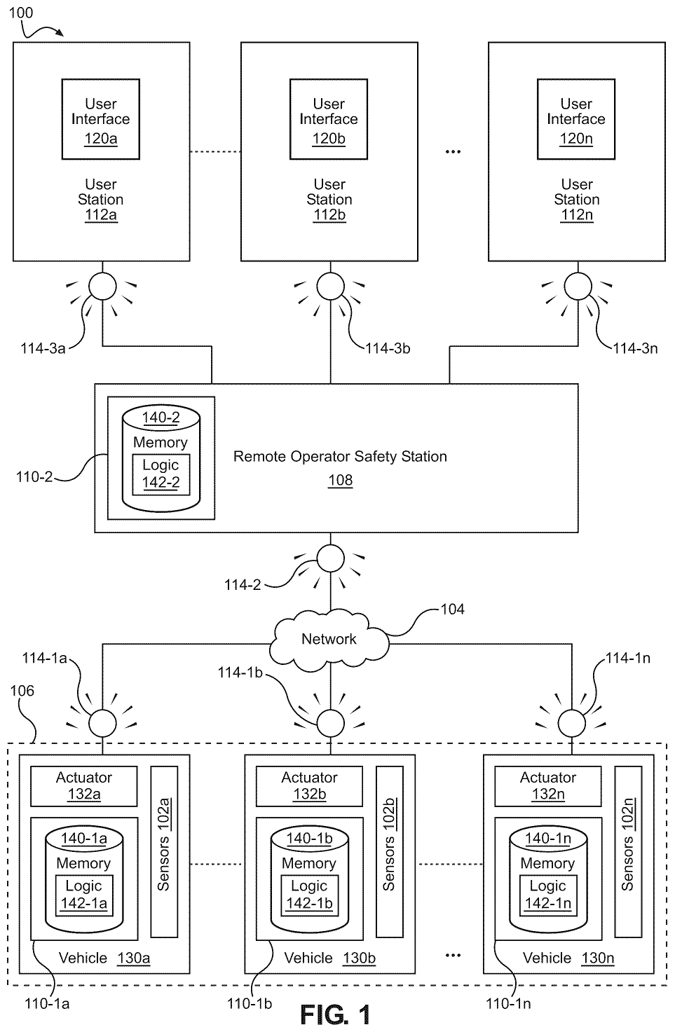

Referring first to FIG. 1, a block diagram of a system 100 according to some embodiments is shown. In some embodiments, an autonomous vehicle 130 or multiple autonomous vehicles 130a-n may each comprise and/or be a part of an overall autonomous vehicle system 106 (e.g., an ADS) that may include one autonomous vehicle 130 or a plurality or fleet of autonomous vehicles 130a-n that may be directly or indirectly in communication with one another. In some embodiments, the ADS 106 may be electronically and/or communicatively coupled to a network 104 (e.g., one or more communications objects such as a wireless transceiver, computer bus, wires, cables, etc.). According to some embodiments, the autonomous vehicles 130 may be in direct or indirect communication with and/or coupled to a communication device 114-1 via which the autonomous vehicles communicate with and/or via the network 104.

In some embodiments, a remote operator safety station 108 may include a user station 112 or a plurality of user stations 112a-n that may be directly or indirectly in communication with one another. In some embodiments, the remote operator safety station 108 is connected to the network 104. According to some embodiments, the remote operator safety station 108 and/or the user station(s) 112 each may be in direct or indirect communication with and/or coupled to a communication device 114 via which the remote operator safety station 108 and/or the user station(s) 112 each communicate with and/or via the network 104. In some embodiments, the remote operator safety station 108 and/or the user station(s) 112 each communicate with the ADS 106 through the network 104. In one or more embodiments, the user station 112 comprises a user interface 120 through which an operator may temporarily control (e.g., via direct manual override or by utilizing partial and/or discrete command options) one or more autonomous vehicles 130. In some embodiments, the user station 112 and user interface 120 are integral with the remote operator safety station 108.

In some embodiments, each autonomous vehicle 130 may comprise a sensor device 102 (in some cases a plurality or a suite of sensor devices, hereinafter referred to as a sensor or sensor device 102 for brevity) communicatively coupled to the autonomous vehicle 130. In some embodiments, the sensor device 102 may comprise a global positioning system (GPS), imaging, pressure sensing, motion sensing, and/or other input devices that are disposed to capture, record, and/or monitor data descriptive of the autonomous vehicle such as a location, speed, engine RPM, route and/or path (hereinafter, a route is a complete planned course to an objective, while a path is a portion of the route immediate the autonomous vehicle), actuator or actuators 132 associated with and/or controlling throttle, brake, and/or steering wheel, status of onboard mechanical elements (e.g., tire inflation, replaceable part maintenance, engine performance, and/or fuel mileage), and/or data descriptive of the status of the immediate surrounding area (e.g., traffic, road conditions, pedestrians, weather, visibility). According to some embodiments, the sensor device 102 may be in communication with and/or may provide indications of the data to an onboard controller 110-1. According to some embodiments, the onboard controller 110-1 and/or the sensor device 102 may be in communication with a memory device 140 (e.g., storing logic 142-1). In accordance with various embodiments herein, the sensor device 102 may be utilized to obtain data descriptive of the autonomous vehicle 130 thereof, such as to facilitate autonomous movement (e.g., by following a set of objective instructions in accordance with the logic 142-1) of the autonomous vehicle 130 along a route from a current location to an objective. In some embodiments, the captured imagery/data may be provided from the sensor device 102 to the controller 110-1 for imagery/sensor data analysis and execution of stored analysis rules and/or logic (e.g., the logic 142-1). According to some embodiments, the logic 142-1 may comprise a first or local AI model and/or module that applies trained AI logic and/or rules to data received from the sensor 102 to autonomously control one or more of the autonomous vehicles 130a-n. In such a manner, for example, data descriptive of the autonomous vehicle 130 may be input into the system 100 and utilized to identify, classify, and/or compute analytic metrics (e.g., fuel economy, time to objective, unforeseen route condition preventing safe traverse of the autonomous vehicle along the route from current position to objective, options to safely traverse unforeseen route conditions) and events with respect to the operation of the autonomous vehicle 130 to the objective. In some embodiments, the communication device 114-1 may be used to communicate the analytic metrics and events with respect to the operation of the autonomous vehicle 130 to the remote operator safety station 108 via the network 104.

In some embodiments, the remote operator safety station 108 may comprise a computing device 110-2 in communication with a memory device 140-2 (e.g., storing logic 142-2). In accordance with various embodiments herein, the communication device 114-2 may receive from the ADS 106 via the network 104 the analytic metrics and events with respect to the operation of the autonomous vehicles 130a-n. In accordance with various embodiments herein, the analytic metrics and events with respect to the operation of the autonomous vehicle 130 may be utilized to facilitate prioritized communication of the analytic metrics and events to an operator or operators via the user interface 120 on the user station 112 communicatively coupled to the remote operator safety station 108. According to some embodiments, the logic 142-2 may comprise a second or remote (e.g., remote from the autonomous vehicles 130a-n) AI model and/or module that applies trained AI logic and/or rules to data received from the ADS to determine whether the data (e.g., reported exceptions) can be handled automatically by the logic 142-2 or whether human input is required.-In such a manner, for example, analytic metrics and events with respect to the operation of the autonomous vehicle 130 may be utilized to identify, classify, and/or compute discrete options (e.g., partial and/or upper-hierarchy commands) with associated instructions for carrying out the prioritized options, and present the discrete options (e.g., partial and/or upper-hierarchy commands) to one or more operators of the user station(s). In accordance with various embodiments herein, the communication device 114-2 may communicate to the ADS via the network 104 the instructions associated with at least one of the discrete options and/or control inputs from an operator.

In some embodiments, the user interface 120 of the user station 112 may include a monitor having inputs such as a display with a keyboard and mouse and/or a touch screen display, and/or various manual input devices such as a joystick, a throttle controller, a brake controller, a steering wheel, and/or any other digital and/or analog input devices for temporarily controlling the steering, throttle, and/or braking of the autonomous vehicle. The monitor (not separately shown in FIG. 1) of the user interface 120 may display information relating to one or more of the autonomous vehicles 130a-n operating at any given time, and/or display one or more discrete options (e.g., partial and/or upper-hierarchy commands) available to an operator to choose for temporary control of at least one of the autonomous vehicles 130a-n.

In some embodiments, the sensor 102 can include a navigation sensor (e.g., a GPS device, etc.), an inertial measurement unit (IMU), an odometry sensor, a distance sensor, a LIDAR sensor, a RADAR sensor, an infrared (IR) imager, a visual camera, or any combination thereof. Other sensors are also possible according to one or more contemplated embodiments. For example, sensor 102 can further include a compass to measure heading, inclinometer to measure an inclination of the autonomous vehicle or a path traveled by the autonomous vehicle (e.g., to assess if the autonomous vehicle may be subject to slippage), a Geiger counter for detection of ionizing radiation, or any combination thereof.

In some embodiments, the navigation sensor can be used to determine relative or absolute position of the autonomous vehicle. In some embodiments, IMU can be used to determine orientation or position of the autonomous vehicle. For example, the IMU can comprise one or more gyroscopes or accelerometers, such as a microelectromechanical system (MEMS) gyroscope or MEMS accelerometer. In some embodiments, the odometry sensor can detect a change in position of the autonomous vehicle over time (e.g., distance). In some embodiments, odometry sensors can be provided for one, some, or all of wheels of the autonomous vehicle, for example, to measure corresponding wheel speed, rotation, and/or revolutions per unit time, which measurements can then be correlated to change in position of the autonomous vehicle. For example, the odometry sensor can include an encoder, a Hall effect sensor measuring speed, or any combination thereof.

In some embodiments, the distance sensor can include an ultrasonic or acoustic sensor for detecting distance or proximity to objects. In some embodiments, the LIDAR system can use laser illumination to measure distances to obstacles or features within an environment surrounding the autonomous vehicle. In some embodiment, the LIDAR system can be configured to provide three-dimensional imaging data of the environment, and the imaging data can be processed (e.g., by the LIDAR system itself or by a module of control system) to generate a 360-degree view of the environment. For example, the LIDAR system can include an illumination light source (e.g., laser or laser diode), an optical assembly for directing light to/from the system (e.g., one or more static or moving mirrors (such as a rotating mirror), phased arrays, lens, filters, etc.), and a photodetector (e.g., a solid-state photodiode or photomultiplier).

In some embodiments, the RADAR system can use irradiation with radio frequency waves to detect obstacles or features within an environment surrounding the autonomous vehicle. In some embodiment, the RADAR system can be configured to detect a distance, position, and/or movement vector of an obstacle or feature within the environment. For example, the RADAR system can include a transmitter that generates electromagnetic waves (e.g., radio frequency or microwaves), and a receiver that detects electromagnetic waves reflected back from the environment.

In some embodiments, the IR sensor can detect infrared radiation from an environment surrounding the autonomous vehicle. In some embodiments, the IR sensor can detect obstacles or features in low-light level or dark conditions, for example, by including an IR light source (e.g., IR light-emitting diode (LED)) for illuminating the surrounding environment. Alternatively or additionally, in some embodiments, the IR sensor can be configured to measure temperature based on detected IR radiation, for example, to assist in classifying a detected feature or obstacle as a person or vehicle.

In some embodiments, the camera sensor can detect visible light radiation from the environment, for example, to determine obstacles or features within the environment. For example, the camera sensor can include an imaging sensor array (e.g., a charge-coupled device (CCD) or complementary metal-oxide semiconductor (CMOS) sensor) and associated optic assembly for directing light onto a detection surface of the sensor array (e.g., lenses, filters, mirrors, etc.). In some embodiments, multiple camera sensors can be provided in a stereo configuration, for example, to provide depth measurements.

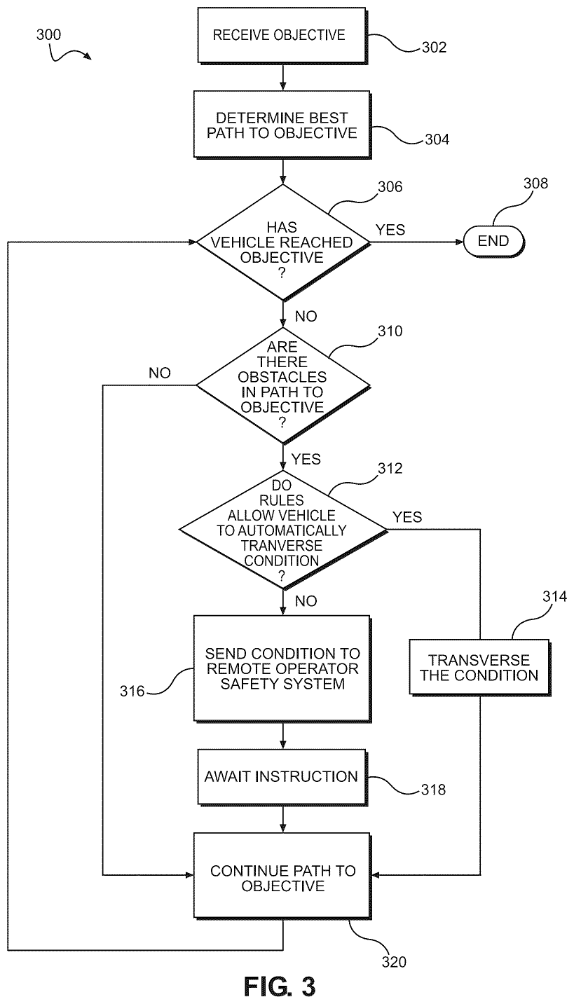

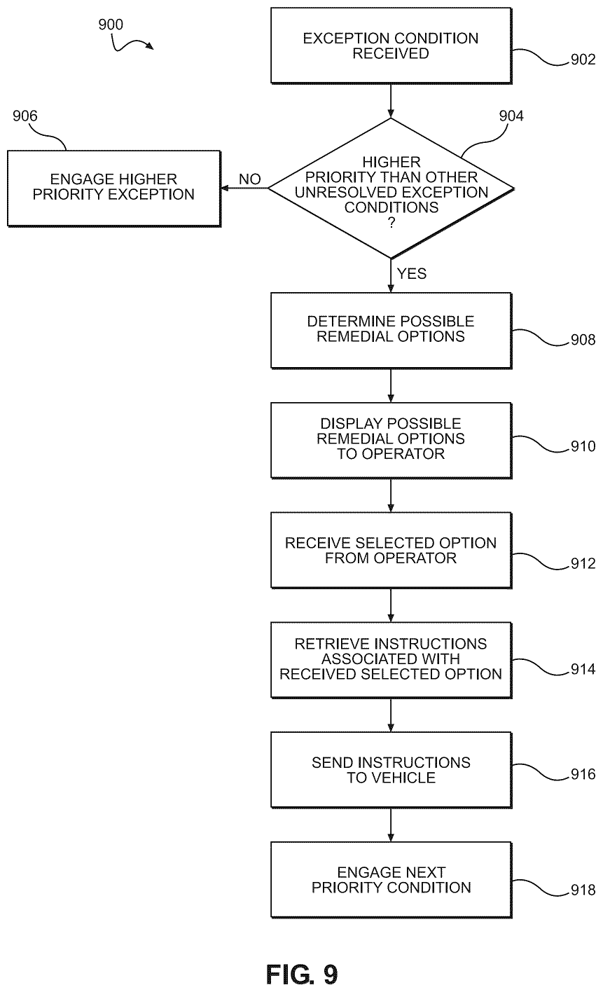

Fewer or more procedures, components, and/or elements 102, 102a-n, 104, 106, 108, 110-1, 110-1a, 110-1b, 110-1n, 110-2, 112, 112a-n, 114-1, 114-1a, 114-1b, 114-1n, 114-3a, 114-3b, 114-3n, 114-2, 120, 130, 130a-n, 132, 132a-n, 140-1, 140-1a, 140-1b, 140-1n, 140-2, 142-1a, 142-1b, 142-1n, 142-2 and/or various configurations of the depicted procedures, components, and/or elements 102, 102a-n, 104, 106, 108, 110-1, 110-1a, 110-1b, 110-1n, 110-2, 112, 112a-n, 114-1, 114-1a, 114-1b, 114-1n, 114-3a, 114-3b, 114-3n, 114-2, 120, 130, 130a-n, 132, 132a-n, 140-1, 140-1a, 140-1b, 140-1n, 140-2, 142-1a, 142-1b, 142-1n, 142-2 may be included in the method 100 without deviating from the scope of embodiments described herein. In some embodiments, the method 100 (and/or portions thereof) may comprise an autonomous vehicle exception handling program, system, and/or platform programmed and/or otherwise configured to execute, conduct, and/or facilitate various methods, procedures, and/or elements, such as the methods 300, 900 of FIG. 3 and/or FIG. 9 herein, and/or portions or combinations thereof.

### III. Supervised Autonomy

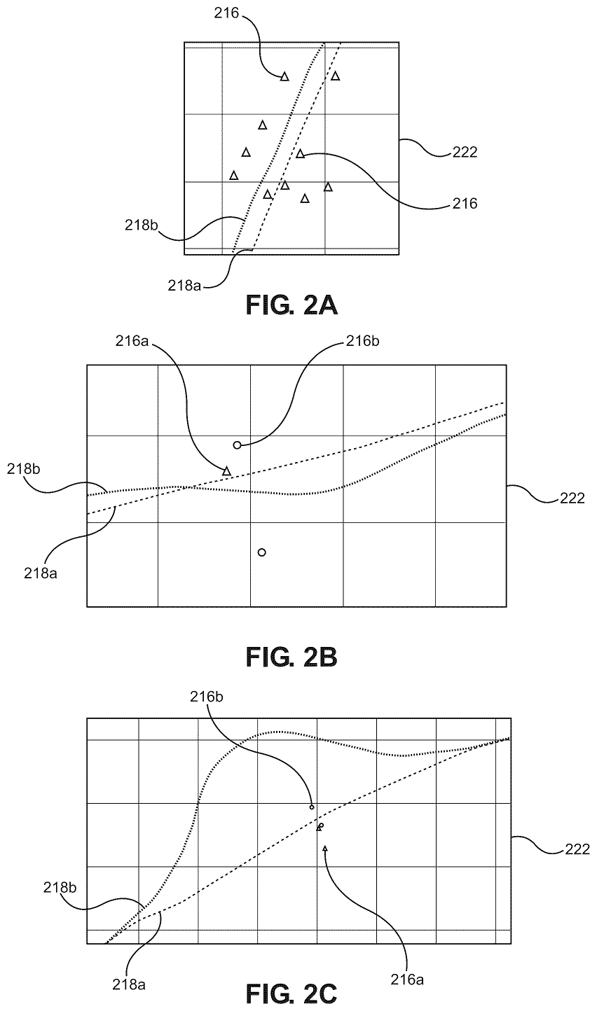

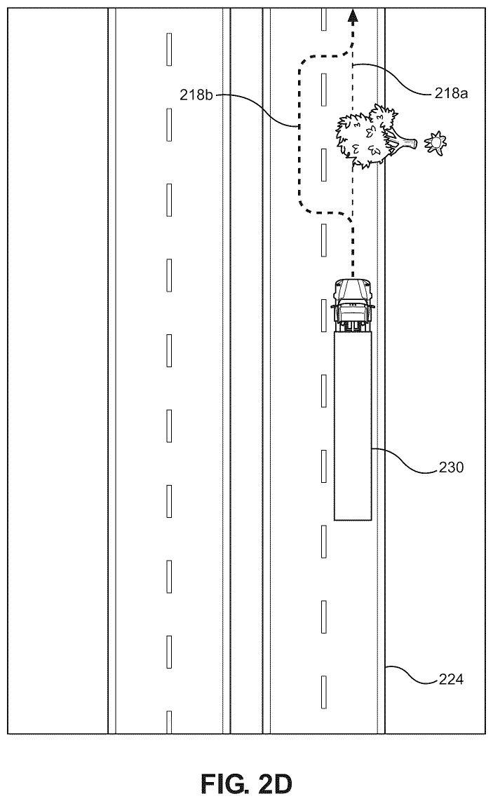

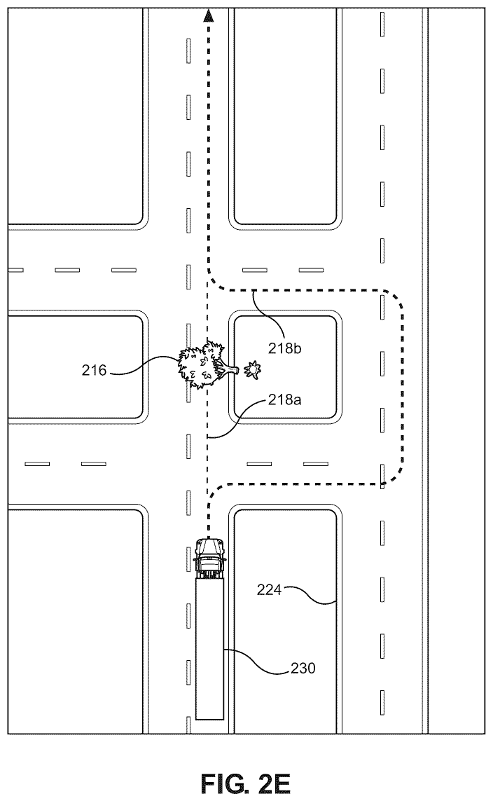

Turning to FIG. 2A-2E, in some embodiments, a system employing a remote operator safety system (e.g., the system 100 of FIG. 1) may provide control modality of supervised autonomy, where an ADS of an autonomous vehicle drives the autonomous vehicle autonomously but a human operator is able to supervise the autonomous driving via a remote safety station and to intervene on-the-fly, for example, by modifying the behavior of the autonomous vehicle through one or more driver-aids either with or without directly tele-operating the autonomous vehicle.

In some embodiments, an ADS onboard each of the autonomous vehicles 230 may identify and overcome conditions that may prevent the autonomous vehicle 230 from reaching its objective. In some embodiments shown in FIG. 2A-2C, the autonomous vehicle 230 may be located in an area 222 without discrete pathways or routes (e.g., a truck yard, a field of battle, a mining area, etc.). In some embodiments shown in FIG. 2D-2E, the autonomous vehicle 230 may be travelling on a discrete pathway or route 224 (e.g., a road, highway, and/or other restricted pathway). In some embodiments, the ADS may compute the fastest route 218a from the current position of the autonomous vehicle 230 to the objective. As the autonomous vehicle 230 advances toward the objective, it may encounter conditions 216 (e.g., other traffic, debris along the route, and/or any other conditions that may prevent the autonomous vehicle 230 from travelling through a point along its route 218a). In some embodiments, the ADS may then utilize information from various sensors and onboard logic to plan and execute an updated route 218b to autonomously avoid the condition 216 along its initial route and/or communicate the condition and updated route 218b to the remote operator safety station and/or other autonomous vehicles in the fleet.

For example, in some embodiments shown in FIG. 2A, the autonomous vehicle may, via various onboard sensors, sense one or more conditions 216 within its route 218a ahead, and offset to an updated route 218b that avoids all sensed conditions 216. In some embodiments as shown in FIG. 2B, the updated route 218b may include a number of offsets on either side of the initial planned route 218a in order to avoid sensed conditions 216a and other conditions 216b that may require the autonomous vehicle 230 to give a wider berth, while keeping speed relatively high to achieve the objective as quickly and/or efficiently as possible. In some embodiments as shown in FIG. 2C, the ADS may take the autonomous vehicle 230 on a wide route around the condition 216b. In some embodiments as shown in FIGS. 2D and 2E, a condition 216 may be sensed on a roadway 224 that is easily and efficiently overcome by the ADS without need of input from the remote safety operator station by changing lanes on a highway or avoiding a block of a roadway and rejoining the initial planned route 218a after the block that contains the condition.

In some embodiments, a video and/or telemetry feed from any of the autonomous vehicles 230 can be streamed via the network to the user interface of one or more user stations of the remote operator safety system such that an operator may oversee operation of any of the autonomous vehicles even while the autonomous vehicle 230 is operating autonomously by the ADS. In some embodiments, the user interface may display on the user interface data descriptive of the autonomous vehicle, such as speed, engine rpm, steering angles, gearing, etc. In some embodiments, the user interface can also include information from the ADS of the autonomous vehicle, such as world model and/or local map, planned route and/or trajectory, ADS status, ADS warnings, etc.

In some embodiments, based on the overlaid information (or any other information conveyed by the remote operator safety station to the operator), the operator can use the user interface to adjust the driving behavior of the autonomous vehicle 230 at any time. In some embodiments, the adjustments available to the operator may include any of the discrete option/command modalities (e.g., partial and/or upper-hierarchy commands) described herein including or in addition to lateral offset control, speed offset control, ADS driving aggressiveness, and/or any other parameter or modality related to the driving framework of the autonomous vehicle. In some embodiments, the lateral offset control can allow the operator to control how far laterally left or right from a path originally determined by the ADS that autonomous vehicle should now follow. For example, this can allow the operator to dictate operation by a specific offset command (e.g., the ability to tell the autonomous vehicle to hug the left lane marking (e.g., a partial and/or upper-hierarchy command) to steer the vehicle laterally or to allow two autonomous vehicles operating within a truck yard to utilize the same path while travelling opposite directions to give one another enough lateral offset to pass by safely) as opposed to providing a command to change the steering angle of the wheels (e.g., an individual/lower-hierarchy command). This can be useful to avoid road hazards, to give way to oncoming vehicles, to adjust the location of line-striping, etc. In some embodiments, the speed offset control can allow the operator to adjust the speed up or down by an inputted value (e.g., +5 mph, −5 mph, etc.), by an inputted multiplier (e.g., 2×, 0.5×, etc.), by setting a maximum speed, by setting a minimum speed, and/or by any combination thereof. The “aggressiveness” of the ADS can also be adjusted on-the-fly by the operator, for example, to allow the autonomous vehicle to get closer to objects (e.g., to squeeze through tight areas, especially in congested roadways). For example, the level of aggressiveness to effectively drive on a road in New York City may be significantly different than in rural areas in upstate New York, e.g., without the operator being required to define which sets of individual/lower-hierarchy commands may be required for such an aggressiveness level setting. The autonomous vehicle (and/or remote operator safety station system) may, for example, store definitions of and/or rules pertaining to one or more sets of individual/lower-hierarchy commands that correspond to identified partial and/or upper-hierarchy commands, e.g., defined by a remote safety station system operator.

Fewer or more procedures, components, and/or elements 216, 216a-b, 218a-b, 222, 224, 230 and/or various configurations of the depicted procedures, components, and/or elements 216, 216a-b, 218a-b, 222, 224, 230 may be included without deviating from the scope of embodiments described herein. In some embodiments, such a system and/or method (and/or portions thereof) may comprise an autonomous vehicle exception handling program, system, and/or platform programmed and/or otherwise configured to execute, conduct, and/or facilitate various methods, procedures, and/or elements, such as the methods 300, 900 of FIG. 3 and/or FIG. 9 herein, and/or portions or combinations thereof.

### IV. Method of ADS Operation

Turning to FIG. 3, a flow diagram of a method 300 according to some embodiments is shown. In some embodiments, the system of the method 300 described below may comprise an ADS that may be used in conjunction with the vehicles 130 and/or 230 of FIG. 1 and/or FIG. 2A-E and/or otherwise may be associated with one or more of the controller devices 110-1 in conjunction with one or more of the sensors 102 of FIG. 1.

The process diagrams and flow diagrams described herein do not necessarily imply a fixed order to any depicted actions, steps, and/or procedures, and embodiments may generally be performed in any order that is practicable unless otherwise and specifically noted. While the order of actions, steps, and/or procedures described herein is generally not fixed, in some embodiments, actions, steps, and/or procedures may be specifically performed in the order listed, depicted, and/or described and/or may be performed in response to any previously listed, depicted, and/or described action, step, and/or procedure. Any of the processes and methods described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); (e.g., the memory/data devices 140 of FIG. 1 herein) may store thereon instructions that when executed by a machine (such as a computerized processor) result in performance according to any one or more of the embodiments described herein.

In some embodiments, at 302, the ADS may receive an objective (e.g., travel to a destination, hook up a trailer at a location, unhook a trailer at a location, hook up a king pin at a location) from an operator via an onboard user interface or remotely via the communication device onboard the autonomous vehicle. The objective may include simply traveling from the current location to the objective or may include maneuvers such as reversing a trailer into a parking spot, performing a three-point turn to line the rear of the autonomous vehicle up with a trailer, and/or pulling into a maintenance bay for maintenance or repair. According to some embodiments, the method 300 may also or alternatively comprise identifying the objective. The objective and/or data descriptive and/or indicative of the objective may, for example, be stored in a database, file, and/or resident in programmed computer code executed by the method 300. In some embodiments, the ADS may execute objective logic to determine the best path or route to the objective at 304, e.g., taking into account current location, objective location, any maneuvers necessary, traffic at current location and at objective, and/or conditions along the route communicated to the autonomous vehicle by the remote operator safety station and/or other autonomous vehicles in the fleet.

In some embodiments, at certain intervals or frequency (e.g., 100 Hz), the autonomous vehicle may detect whether it has reached the objective or not, at 306. If the objective has been reached, then the method 300 may, in some embodiments, end at 308, and/or the ADS may await further instruction. In some embodiments, if the objective has not yet been reached, then the ADS on the autonomous vehicle may use onboard sensors to detect whether there are obstacles or other conditions in the path ahead that would prevent the autonomous vehicle from reaching the objective using the ADS logic along its current route, at 310. In some embodiments, the onboard sensors may comprise, for example, a camera and/or a ranging device such as a LIDARi) or a iRADARi) device. In some embodiments, the onboard sensors may comprise a multispectral imaging device capable of capturing three or four band imagery data (e.g., RGB plus Near IR). The imagery and/or other data captured by the onboard sensors may generally comprise any type, quantity, and/or format of digital, analog, photographic, video, pressure, light, strain, and/or other sensor data descriptive of the autonomous vehicle and/or the path thereof. According to some embodiments, the data captured and/or acquired by the onboard sensors may comprise one or more images and/or ranging data captured from different positions and/or locations in or on the autonomous vehicle, such as a plurality of individual images taken at different bearings from a given position and/or a single panoramic image taken from the given position.

In some embodiments, if there are no obstacles in the immediate path, the autonomous vehicle may continue on the path toward the objective, at 320. In some embodiments, if there are conditions in the immediate path of the autonomous vehicle, at 312, the ADS may execute external condition logic to analyze rules associated with the path or route (e.g., road rules, yard rules, vehicle specific rules) that allow the autonomous vehicle to traverse the condition and continue on an updated path toward the objective and/or back to the initial path set by the ADS. If the external condition logic allows the autonomous vehicle to traverse the condition (e.g., change lanes, change paths, find an updated route), then the ADS may control the autonomous vehicle to traverse the condition at 314 and continue on toward the objective, at 320.

In some embodiments, if the rules do not allow the ADS to traverse the condition without intervention, then the ADS may execute exception condition logic to analyze the condition and communicate data descriptive of the condition (e.g., a condition type, a priority of the condition according to exception condition priority logic, path type, and/or other factors associated with the condition and/or the area around the autonomous vehicle) via the network to the remote operator safety station, at 316. In some embodiments, the ADS may then await and implement the instructions that are received from the remote operator safety station at 318 according to embodiments described herein, and then continue on toward the objective at 320.

Fewer or more procedures, components, and/or elements 302, 304, 306, 308, 310, 312, 314, 316, 318, 320 and/or various configurations of the depicted procedures, components, and/or elements 302, 304, 306, 308, 310, 312, 314, 316, 318, 320 may be included in the method 300 without deviating from the scope of embodiments described herein. In some embodiments, the method 300 (and/or portions thereof) may comprise and/or be implemented or conducted by an autonomous vehicle exception handling program, system, and/or platform programmed and/or otherwise configured to execute, conduct, and/or facilitate various methods, procedures, and/or elements, such as the method 300 of FIG. 3, and/or portions or combinations thereof.

### V. Controller in Use with the Automated Driving System (ADS)

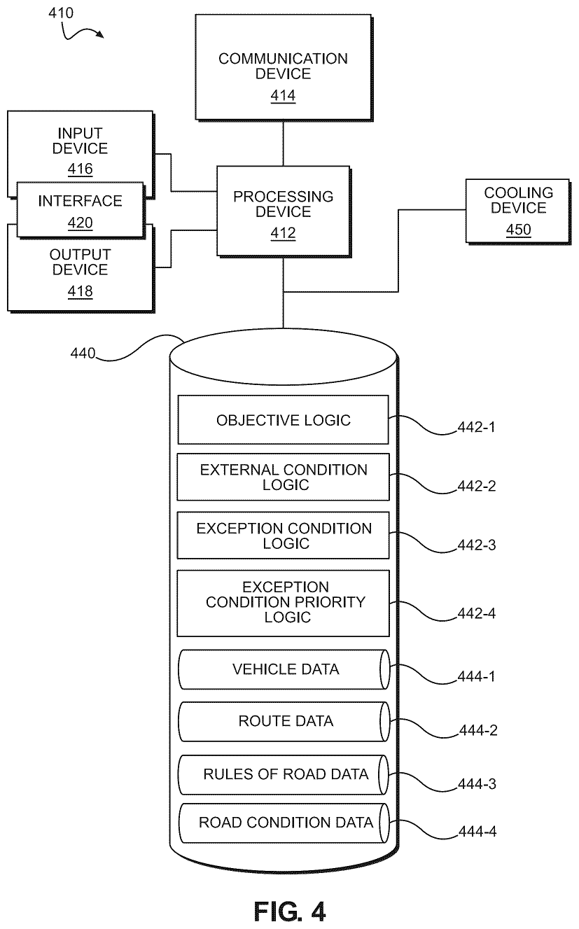

Turning to FIG. 4, a block diagram of a controller or apparatus 410 according to some embodiments is shown. In some embodiments, the apparatus 410 may be similar in configuration and/or functionality to one or more of the controller device 110 of FIG. 1 herein, and/or in conjunction with the autonomous vehicle 130 and/or 230 of FIG. 1 and/or FIG. 2A-E herein. In some embodiments, the apparatus 410 may, for example, execute, process, facilitate, and/or otherwise be associated with the method 300 of FIG. 3 herein, and/or portions thereof. In some embodiments, the apparatus 410 may comprise a processing device 412, a communication device 414, an input device 416, an output device 418, an interface 420, a memory device 440 (storing various programs and/or instructions 442 and data 444), and/or a cooling device 450.

According to some embodiments, the processor 412 may be or include any type, quantity, and/or configuration of processor that is or becomes known. The processor 412 may comprise, for example, an Intel® IXP 2800 network processor or an Intel® XEON™ Processor coupled with an Intel® E7501 chipset. In some embodiments, the processor 412 may comprise multiple interconnected processors, microprocessors, and/or micro-engines. According to some embodiments, the processor 412 (and/or the apparatus 410 and/or other components thereof) may be supplied power via a power supply (not shown), such as a battery, an Alternating Current (AC) source, a Direct Current (DC) source, an AC/DC adapter, solar cells, and/or an inertial generator. In the case that the apparatus 410 comprises a server, such as a blade server, necessary power may be supplied via a standard AC outlet, power strip, surge protector, and/or Uninterruptible Power Supply (UPS) device.

In some embodiments, the communication device 414 may comprise any type or configuration of communication device that is or becomes known or practicable. The communication device 414 may, for example, comprise a Network Interface Card (NIC), a telephonic device, a cellular network device, a router, a hub, a modem, and/or a communications port or cable. In some embodiments, the communication device 414 may be coupled to receive user input data, e.g., from a user device (not shown in FIG. 4). The communication device 414 may, for example, comprise a Bluetooth® Low Energy (BLE) and/or RF receiver device and/or a camera or other imaging device that acquires data from a user (not separately depicted in FIG. 4) and/or a transmitter device that provides the data to a remote server and/or server or communications layer (also not separately shown in FIG. 4). According to some embodiments, the communication device 414 may also or alternatively be coupled to the processor 412. In some embodiments, the communication device 414 may comprise an IR, RF, Bluetooth™, Near-Field Communication (NFC), and/or Wi-Fi® network device coupled to facilitate communications between the processor 412 and another device (such as a remote user device, not separately shown in FIG. 4).

In some embodiments, the input device 416 and/or the output device 418 are communicatively coupled to the processor 412 (e.g., via wired and/or wireless connections and/or pathways) and they may generally comprise any types or configurations of input and output components and/or devices that are or become known, respectively. The input device 416 may comprise, for example, a keyboard that allows an operator of the apparatus 410 to interface with the apparatus 410 (e.g., by an operator to input an objective and/or one or more partial and/or upper-hierarchy commands for the autonomous vehicle, as described herein). In some embodiments, the input device 416 may comprise a sensor, such as a camera, sound, light, distance ranging, and/or proximity sensor, configured to measure parameter values and report measured values via signals to the apparatus 410 and/or the processor 412. The output device 418 may, according to some embodiments, comprise a display screen and/or other practicable output component and/or device. The output device 418 may, for example, provide an interface (such as the interface 420) via which operating instructions, objective data, and/or other operating parameters to a user (e.g., via a website and/or mobile device application). According to some embodiments, the input device 416 and/or the output device 418 may comprise and/or be embodied in a single device, such as a touch-screen monitor or a personal handheld device.

The memory device 440 may comprise any appropriate information storage device that is or becomes known or available, including but not limited to, units and/or combinations of magnetic storage devices (e.g., a hard disk drive), optical storage devices, and/or semiconductor memory devices, such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 440 may, according to some embodiments, store one or more of objective logic 442-1, external condition logic 442-2, exception condition logic 442-3, exception condition priority logic 442-4, vehicle data 444-1, route data 444-2, rules of road data 444-3, and/or road condition data 444-4. In some embodiments, the objective logic 442-1, external condition logic 442-2, exception condition logic 442-3, exception condition priority logic 442-4, vehicle data 444-1, route data 444-2, rules of road data 444-3, and/or road condition data 444-4 may be utilized by the processor 412 to analyze input received by the communication device 414 from the sensor(s) and provide output information via the output device 418 and/or the communication device 414.

According to some embodiments, the objective logic 442-1 may be operable to cause the processor 412 to process the vehicle data 444-1, route data 444-2, rules of road data 444-3, and/or road condition data 444-4 in accordance with embodiments as described herein. Vehicle data 444-1, route data 444-2, rules of road data 444-3, and/or road condition data 444-4 received via the input device 416 and/or the communication device 414 may, for example, be analyzed, sorted, filtered, decoded, decompressed, ranked, scored, plotted, and/or otherwise processed by the processor 412 in accordance with the objective logic 442-1. In some embodiments, vehicle data 444-1, route data 444-2, rules of road data 444-3, and/or road condition data 444-4 may be fed by the processor 412 through one or more mathematical and/or statistical formulas and/or models in accordance with the objective logic 442-1 to merge transcribe, decode, convert, and/or otherwise process user input (e.g., partial and/or upper-hierarchy commands) and/or destination data to compute a route (e.g., a set of objective instructions that control the autonomous vehicle's operation) for the autonomous vehicle to reach the objective (e.g., a location, pose, vehicle state, etc.), as described herein.

In some embodiments, the external condition logic 442-2 may be operable to cause the processor 412 to process the vehicle data 444-1, route data 444-2, rules of road data 444-3, and/or road condition data 444-4 in accordance with embodiments as described herein. Vehicle data 444-1, route data 444-2, rules of road data 444-3, and/or road condition data 444-4 received via the input device 416 and/or the communication device 414 may, for example, be analyzed, sorted, filtered, decoded, decompressed, ranked, scored, plotted, and/or otherwise processed by the processor 412 in accordance with the external condition logic 442-2. In some embodiments, vehicle data 444-1, route data 444-2, rules of road data 444-3, and/or road condition data 444-4 may be fed by the processor 412 through one or more mathematical and/or statistical formulas and/or models in accordance with the external condition logic 442-2 to identify, classify, and/or otherwise compute an updated route to traverse a condition preventing the autonomous vehicle from completing the initial route as computed, as described herein.

According to some embodiments, the exception condition logic 442-3 may be operable to cause the processor 412 to process the vehicle data 444-1, route data 444-2, rules of road data 444-3, and/or road condition data 444-4 in accordance with embodiments as described herein. Vehicle data 444-1, route data 444-2, rules of road data 444-3, and/or road condition data 444-4 received via the input device 416 and/or the communication device 414 may, for example, be analyzed, sorted, filtered, decoded, decompressed, ranked, scored, plotted, and/or otherwise processed by the processor 412 in accordance with the exception condition logic 442-3. In some embodiments, vehicle data 444-1, route data 444-2, rules of road data 444-3, and/or road condition data 444-4 may be fed by the processor 412 through one or more mathematical and/or statistical formulas and/or models in accordance with the exception condition logic 442-3 to identify, classify, and/or otherwise compute whether a condition preventing the autonomous vehicle from completing the initial route computed is to be communicated to an operator at a user station of the remote operator safety station and to find a safe location to stop and/or hold, if necessary, as described herein.

According to some embodiments, the exception condition priority logic 442-4 may be operable to cause the processor 412 to process the vehicle data 444-1, route data 444-2, rules of road data 444-3, and/or road condition data 444-4 in accordance with embodiments as described herein. Vehicle data 444-1, route data 444-2, rules of road data 444-3, and/or road condition data 444-4 received via the input device 416 and/or the communication device 414 may, for example, be analyzed, sorted, filtered, decoded, decompressed, ranked, scored, plotted, and/or otherwise processed by the processor 412 in accordance with the exception condition priority logic 442-5. In some embodiments, vehicle data 444-1, route data 444-2, rules of road data 444-3, and/or road condition data 444-4 may be fed by the processor 412 through one or more mathematical and/or statistical formulas and/or models in accordance with the exception condition priority logic 442-4 to generate and/or communicate a priority of an exception condition event (e.g., an autonomous emergency vehicle may generate the highest priority, an autonomous vehicle carrying time-sensitive material may generate a higher priority than normal, an autonomous vehicle carrying a passenger with no time constraint may generate a normal priority, an autonomous vehicle simply being relocated may generate a lower priority than normal, and/or any other desired specific rules with respect to priority around a truck yard, a municipality, a highway, and/or any other location may be input and saved within the exception priority logic 442-4), as described herein.

According to some embodiments, the apparatus 410 may comprise the cooling device 450. According to some embodiments, the cooling device 450 may be coupled (physically, thermally, and/or electrically) to the processor 412 and/or to the memory device 440. The cooling device 450 may, for example, comprise a fan, heat sink, heat pipe, radiator, cold plate, and/or other cooling component or device or combinations thereof, configured to remove heat from portions or components of the apparatus 410.

Any or all of the exemplary instructions and data types described herein and other practicable types of data may be stored in any number, type, and/or configuration of memory devices that is or becomes known. The memory device 440 may, for example, comprise one or more data tables or files, databases, table spaces, registers, and/or other storage structures. In some embodiments, multiple databases and/or storage structures (and/or multiple memory devices 440) may be utilized to store information associated with the apparatus 410. According to some embodiments, the memory device 440 may be incorporated into and/or otherwise coupled to the apparatus 410 (e.g., as shown) or may simply be accessible to the apparatus 410 (e.g., externally located and/or situated).

Fewer or more procedures, components, and/or elements 412, 414, 416, 418, 420, 440, 442, 444, 450 and/or various configurations of the depicted procedures, components, and/or elements 412, 414, 416, 418, 420, 440, 442, 444, 450 may be included in the apparatus 410 without deviating from the scope of embodiments described herein. In some embodiments, the apparatus 410 (and/or portions thereof) may comprise an autonomous vehicle exception handling program, system, and/or platform programmed and/or otherwise configured to execute, conduct, and/or facilitate various methods, procedures, and/or elements, such as the methods 300, 900 of FIG. 3 and/or FIG. 9 herein, and/or portions or combinations thereof.

### VI. Remote Operator Safety Station

In one or more embodiments, a remote operator safety station can be configured to simultaneously manage (e.g., autonomously and/or by one or more human operators interfacing with the remote safety station) multiple autonomous vehicles without otherwise overloading the human operator(s). In some embodiments, the remote safety station can provide the human operator(s) with the freedom to augment and control the overall behavior of the autonomous vehicles, for example, to ensure safe operation in in the face of unexpected obstacles or events. Alternatively or additionally, in some embodiments, the remote safety station can control one or more of the autonomous vehicles to execute intelligence, surveillance, and/or reconnaissance missions in a dynamic urban environment.

In some embodiments, notifications by the remote safety station can be configured using a configuration file. Such notifications can automatically alert the operator and provide action buttons for execution of one or more operations or control modalities, partial and/or upper-hierarchy commands, and/or discrete options. The notifications absolve the operator from having to notice all anomalies, instead displaying anomalies in a convenient readable manner. The actions buttons can allow the operator to, if necessary, reboot part or all of the control system of the autonomous vehicle, restart a particular service running on the control system, or any other customizable action. In some embodiments, a hierarchical command and control framework can be used to monitor and control the behavior of the ADS of the autonomous vehicle. For example, the framework can be constructed of a hierarchy of monitor nodes that each individually report status as well as event triggers based on a configurable set of if/then rules. The output of the monitor nodes at the lower levels of the hierarchy can be used as inputs to higher levels of the hierarchy, allowing for progressively-complex behaviors. The configurable if/then rules can allow the information to be salient, prioritized, and relevant to the context/scenario. In addition, the event triggers allow for behaviors to automatically be executed without the need for operator involvement or to provide a list of actions for the operator to choose from.

In some embodiments, the event-based decision making enabled by the hierarchical command and control framework can include, but are not limited to: (i) detours and route deviations; (ii) permission to break rules; (iii) reverse along route; (iv) ignore obstacles; and/or (v) ignore/restart sensor. For example, for detours and route deviations, when the remote safety station or the autonomous vehicle detects that a road is blocked, the remote safety station can alert the operator of the blockage and can present detour/deviation options, such as U-turn selection, K-turn selection, drive out of lane to drive around the blockage, etc. For example, for permission to break rules, when the remote safety station or the autonomous vehicle detects an edge case, the remote safety station can present to the user an option for breaking a rule of the road (e.g., to allow the autonomous vehicle crossing of a double-yellow line because the current lane of travel is blocked). For example, for reversing along a route, when the remote safety station or the autonomous vehicle detects there are no options for moving forward, the remote safety station can present to the user an option for backing up along the route. For example, for ignoring obstacles, when the autonomous vehicle has detected an obstacle that impinges upon its current route, the remote safety station can present to the user an option to command the ADS of the autonomous vehicle to ignore the obstacle, thereby allowing the autonomous vehicle to drive through or over the obstacle (e.g., when the object is otherwise traversable, such a vegetation or a paper bag in the road). For example, the option for ignoring/restarting sensor can allow an operator to troubleshoot malfunctioning hardware.

In some embodiments, the location-based decision making enabled by the hierarchical command and control framework can provide human-in-the-loop decision-making, such as path option selection and/or tele-operation request. For example, in path option selection, when the autonomous vehicle gets to a location where several viable path options exist, the remote safety station can present the options to the operator in order to make the decision. For example, in tele-operation request, when the autonomous vehicle drives to a location outside of its ordinary operating area or geo-fence, the remote safety station can present the option for tele-operation to the operator.

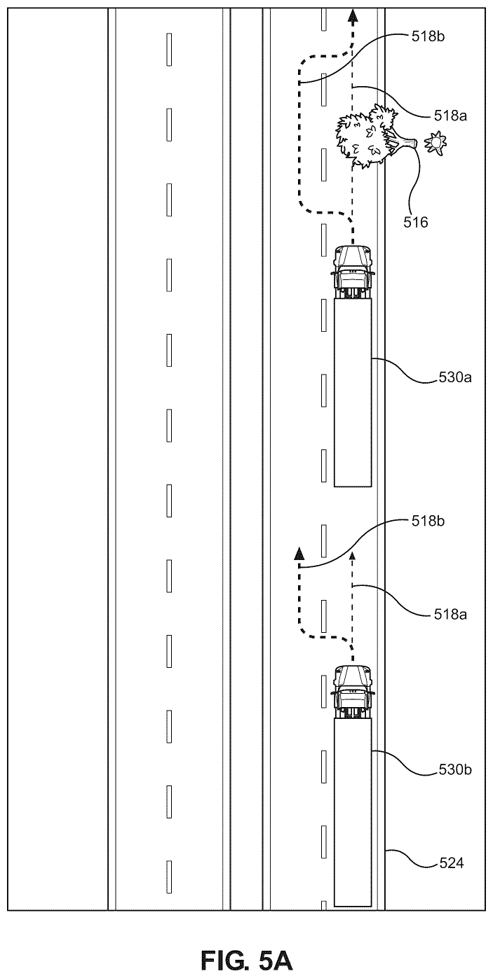

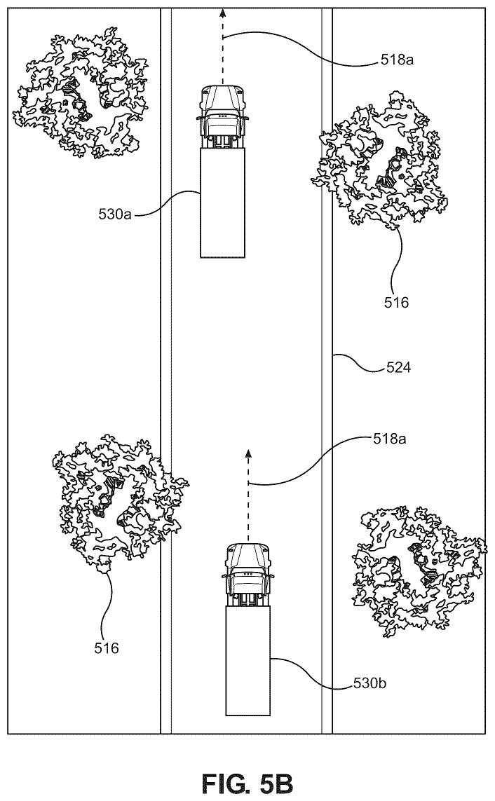

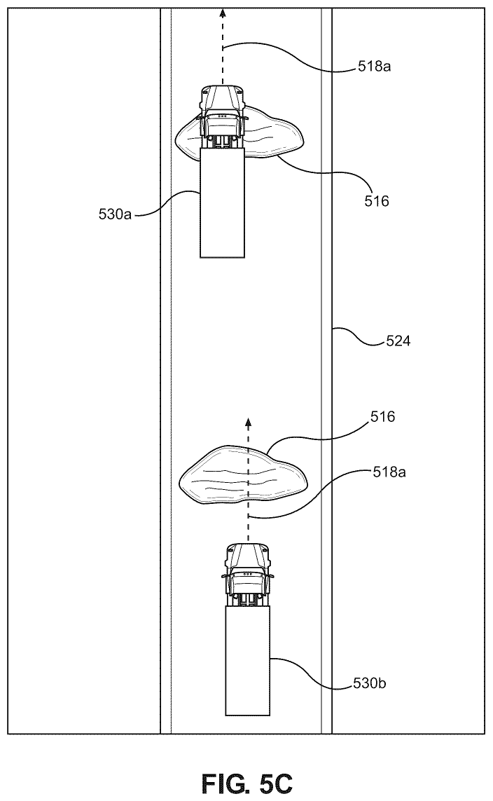

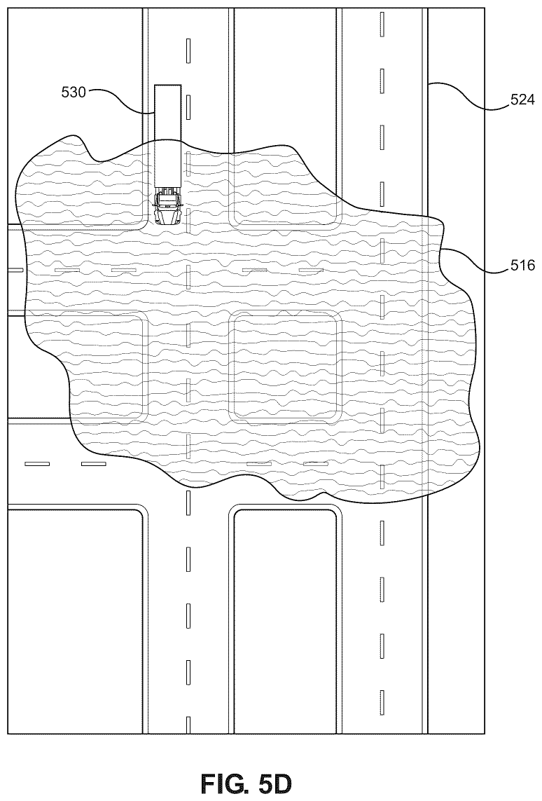

Referring to FIG. 5A-D, in one or more embodiments, the remote safety operator system may provide the control modality of supervised autonomy to multiple autonomous vehicles 530. In some embodiments, supervised autonomy may allow an ADS of each of the autonomous vehicles 530 to drive autonomously, but a human operator is able to supervise the autonomous driving via the user interface of the remote operator safety station and to intervene on-the-fly, for example, by modifying the behavior of at least one of the autonomous vehicles through one or more driver-aids either with or without directly tele-operating the autonomous vehicle.

In some embodiments, the ADS onboard each of the autonomous vehicles 530 may identify and overcome conditions 516 that may prevent the autonomous vehicle 530 from reaching its objective and communicate (e.g., either directly or via the network) the conditions 516 to the other autonomous vehicles 530 in the fleet. In some embodiments as shown in FIG. 5A, an autonomous vehicle 530a may approach a condition 516 (e.g., a tree or other obstacle) preventing the autonomous vehicle 530a from continuing on the current path of the initial planned route 518a. The ADS of the vehicle 530a may compute an updated route 518b (e.g., changing lanes to avoid the condition) autonomously without operator intervention, and then communicate the condition and the updated route 518b to another autonomous vehicle 530b. The autonomous vehicle 530b may then have more time to prepare for the updated route 518b (e.g., moving to the left lane of roadway 524) which may then be accomplished more efficiently given traffic (e.g., in a high traffic area the autonomous vehicle 530b may have more time to adjust speed to find a space to move to the left lane of roadway 524) and/or other road conditions in the area of autonomous vehicle 530b. In some embodiments as shown in FIG. 5B, the condition 516 (e.g., a tree overhanging a roadway) may not require the autonomous vehicle 530a from updating the immediate path 518a of the route at all, and the condition 516 may be ignored. This may be communicated to autonomous vehicle 530b and the autonomous vehicle 530b may simply ignore the condition 516 based on the communication from the autonomous vehicle 530a.

In some embodiments, operator intervention may be necessary for an autonomous vehicle 530 to traverse a condition 516 that the ADS is unable to traverse on its own. As shown in FIG. 5C, a first autonomous vehicle 530a approaches a condition 516 that requires operator intervention (e.g., is identified as an exception) and communicates the exception condition 516 to the remote operator safety station which relays the exception condition 516 to an operator at a user station of the remote operator safety station. In some embodiments, the operator may recognize that the autonomous vehicle 530a can traverse the condition without deviating from planned route 518a but may cause vehicle issues at speed (e.g., a puddle of unknown depth on the roadway). In some embodiments, the user interface may display a number of discrete options (e.g., partial and/or upper-hierarchy commands) having associated remedial instructions (e.g., a group or list of distinct and/or individual/lower-hierarchy commands and/or instructions that when applied together accomplish the discrete remedial option) that the autonomous vehicle 530a may follow to traverse the exception condition. In some embodiments, a manual override option may be available to the operator to take over driving operation of the autonomous vehicle. In some embodiments, the operator may select one of the discrete options or the manual override option and may apply the decision to autonomous vehicle 530a and/or communicate the decision to another autonomous vehicle 530b in the fleet such that when autonomous vehicle 530b encounters the exception condition 516, the same remedial instructions (e.g., continue through the condition but at a slower speed than is normal on that path) to traverse the exception condition 516 are followed. In some embodiments as shown in FIG. 5D, an exception condition 516 may be communicated to the remote operator safety station that requires unique manual operation (e.g., a low visibility condition such as fog or smoke whereby sensors onboard the autonomous vehicle are rendered inoperative or are operating an efficacy that is too low for autonomous operation). The ADS onboard the autonomous vehicle 530 may not have enough information to continue through the condition 516 autonomously, but an operator at a user station of the remote operator safety station may have enough information from the onboard sensors (e.g., the operator may be able to see well enough via the user interface and onboard camera(s)) to slowly and safely traverse through the low visibility condition, but the same solution may not apply to other autonomous vehicles 530 in the fleet due to changing conditions.

Fewer or more procedures, components, and/or elements 516, 518a-b, 524, 530a-b and/or various configurations of the depicted procedures, components, and/or elements 516, 518a-b, 524, 530a-b may be included without deviating from the scope of embodiments described herein. In some embodiments, such a system and/or method (and/or portions thereof) may comprise an autonomous vehicle exception handling program, system, and/or platform programmed and/or otherwise configured to execute, conduct, and/or facilitate various methods, procedures, and/or elements, such as the methods 300, 900 of FIG. 3 and/or FIG. 9 herein, and/or portions or combinations thereof.

### VII. User Interface of the Remote Operator Safety Station

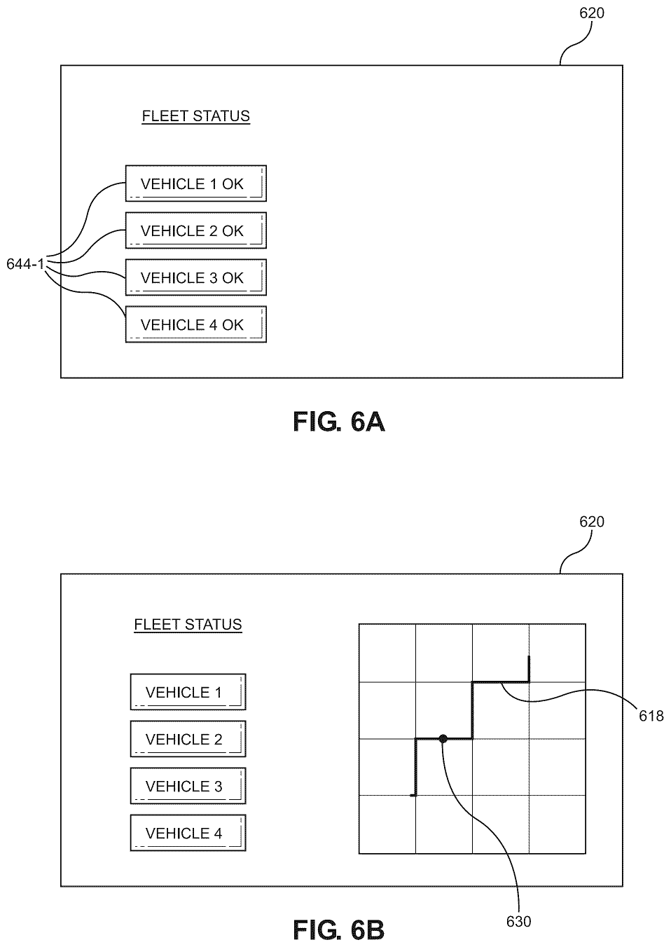

Turning to FIGS. 6A-B, 7A-B, and 8A-B, a user interface 620, 720, 820 according to some embodiments is shown. In some embodiments, the user interface 620 may be similar in configuration and/or functionality to one or more of the user interface 120 and/or 420 of FIG. 1 and/or FIG. 4 herein, and/or in conjunction with the user station 112 and/or remote operator safety station 108 of FIG. 1 herein, and/or may display vehicle data 444-1, route data 444-2, rules of road data 444-3, and/or road condition data 444-4 of FIG. 4 herein. In some embodiments, the user interface 620 may, for example, provide status information regarding one or more autonomous vehicles and/or provide context-dependent input options to an operator. In one or more embodiments, an operator may oversee, for example, four autonomous vehicles operating normally as shown in FIG. 6A. The operator may wish to see specific data regarding the operation of one of the autonomous vehicles and may click or otherwise choose to see data specific to one of the autonomous vehicles (e.g., progress toward objective (as shown in FIG. 6B), fuel usage and economy, engine data such as RPM, speed, direction, location, and/or a feed from one or more of the visual sensors onboard the autonomous vehicle).

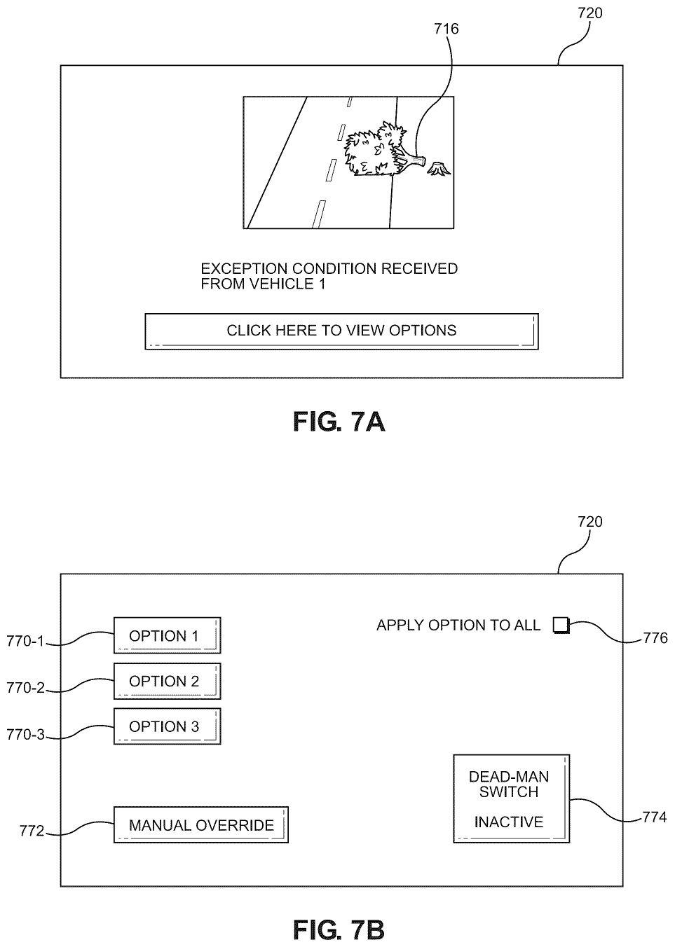

Referring to FIG. 7A-B, in some embodiments the user interface 720 may display to a user an exception condition 716 received from the ADS of an autonomous vehicle via the network from the remote operator safety station. The user interface 720 may display to an operator data relating to the exception condition 716 (e.g., a visual representation of the exception condition (shown in FIG. 7A) or any other appropriate data relating to the exception condition) and/or an interface input element such as the “Click here to view options” button as shown. In some embodiments as shown in FIG. 7B, in another screen or screen instance (which may be accessed, called, and/or served or generated in response to an activation of an interface input element), a set of discrete options 770 may be presented to the operator based on the exception condition 716 communicated to the remote operator safety station.

The set of discrete options 770 may, for example, be identified by either the autonomous vehicle (e.g., executing a first autonomous operation stack and/or Al logic module) or a remote operator safety station (e.g., a controller and/or processor thereof executing a second autonomous operation stack and/or AI logic module) by querying stored data relations and/or rules. In the case of a tree laying across one of two travel ways of a road (i.e., the exception condition 716) as depicted in FIG. 7A, for example, information identifying the exception condition 716 may be utilized to query a database and/or to resolve one or more rules to resolve a computation, identification, and/or selection of the set of discrete options 770. In some embodiments, a first discrete option 770-1 may comprise an option, for example, to drive over the tree, a second discrete option 770-2 may comprise an option to enter into the opposing travel lane to go around the tree, and/or a third discrete option 770-3 may comprise an option to stop and wait for assistance. According to some embodiments, one or more of the discrete options 770 may comprise a partial control or upper-hierarchy command that is related to, invokes, and/or defines a plurality of individual, middle-hierarchy, and/or lower-hierarchy commands. In the example case of the second discrete option 770-2 comprising an option to drive around the obstacle, for example, while the remote operator safety system may simply receive input for the user identifying the second discrete option 770-2, the remote operator safety station and/or the autonomous vehicle may identify each of the plurality of individual commands (e.g., pre-defined commands) related to and/or defined by the second discrete option 770-2. In such a manner, for example, while the input from the user may be discrete and/or high-level, an actuation of the second discrete option 770-2 may cause the autonomous vehicle to execute a plurality of related individual commands and/or actions such as, but not limited to: (i) checking to make sure there are no oncoming vehicles in the other lane, (ii) adjusting a steering actuator to turn the vehicle into the opposing lane, (iii) decreasing the speed of the vehicle to a pre-set lane-change maximum speed, (iv) orienting the vehicle to drive within the opposing land for a distance and/or time that places the vehicle beyond the obstacle, and/or (v) adjusting the steering actuator to turn the vehicle back into the original lane. In some embodiments, an input element 776 (e.g., a radio button, toggle, and/or check box as depicted) may be displayed to apply the chosen discrete option(s) to all autonomous vehicles within a fleet whenever they encounter the same or similar condition.

In some embodiments, an option 772 to manually override the autonomy of the autonomous vehicle may be shown. A manual override may be desired in a condition where either there are no viable options presented to the operator based on the exception condition 716, or where a manual override is the best and/or most efficient option and the operator has the time to manually operate the autonomous vehicle to traverse the exception condition. In some embodiments, a dead-man switch (e.g., a button on the user interface, a pedal, or any other button or switch that the operator must hold activated) may be utilized in conjunction with the manual override that the operator must hold activated while operating the autonomous vehicle manually such that in the event the operator becomes incapacitated, the autonomous vehicle treats the release of the dead man switch as another exception condition and safely ends operation to await further instruction. In some embodiments, the user interface 720 includes a toggle 774 that indicates whether the dead-man switch is activated or not and permits the user to selectively activate or deactivate the dead-man switch functionality.

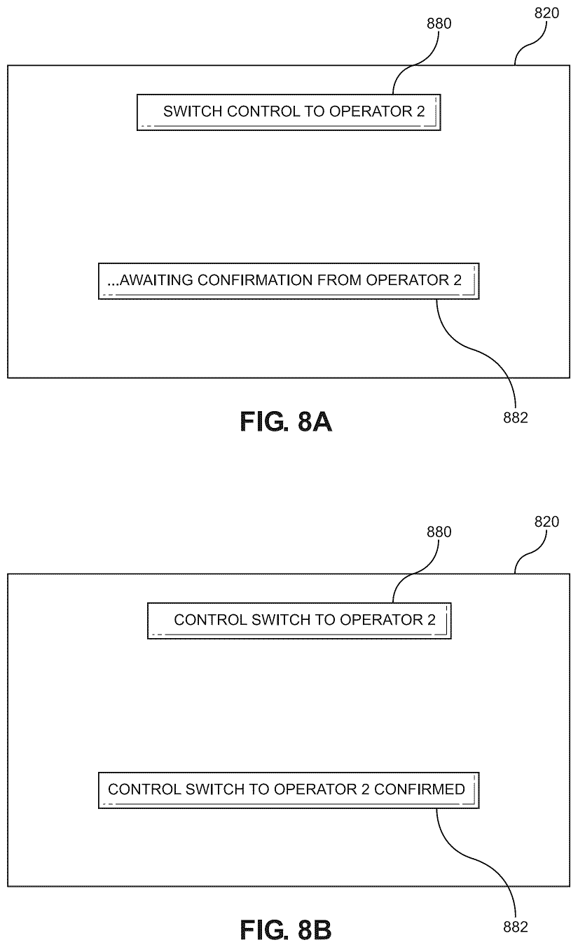

In some embodiments as shown in FIG. 8A-B, there may be more than one operator overseeing a group or fleet of autonomous vehicles. In some embodiments, control of at least one of the autonomous vehicles may be transferred from a first operator to a second (e.g., a temporary transfer for a short-term break for the first operator, and/or a permanent transfer for shift change or the like). It may be desirable to actively confirm that control is transferred from the first to the second operator, and that control is not transferred until the second operator actively confirms receipt of control of the autonomous vehicle or autonomous vehicles. In some embodiments user interface 820 may include an option 880 to switch control to another operator, and may include an indication 882 that the switch to the other operator was confirmed.

### VIII. Method of Remote Operator Safety Station Operation

Turning to FIG. 9, a flow diagram of a method 900 according to some embodiments is shown. In some embodiments, the method 900 may be implemented by a remote operator safety station and/or may be used in conjunction with the remote operator safety station 108 of FIG. 1 and/or otherwise may be associated with one or more of the user stations 160a-n of FIG. 1 in conjunction with one or more of the user interfaces 120a-n, 620, 720, and/or 820 of FIG. 1, FIG. 6A-B, FIG. 7A-B, and/or 8A-B.

In some embodiments, at 902, an exception condition may be received from, e.g., an ADS of one or more autonomous vehicles in the field. In some embodiments, a remote operator safety station may execute vehicle condition priority logic to determine the priority of the exception condition received compared to any other unresolved exception conditions, at 904. If there are other higher priority exception conditions that are currently unresolved, then at 906 the higher priority exception condition may be resolved first.

In some embodiments, the remote operator safety system analyzes the exception condition and may execute remedial option logic to compile a list of possible partial and/or upper-hierarchy commands and/or discrete remedial options (e.g., ignore condition, traverse along path at a slower speed, find another path, return to maintenance facility, or any other remedial option that may be appropriate for the exception condition) at 908. In some embodiments, each of the discrete remedial options/commands may include a list of instructions stored in memory operably coupled to the remote operator safety station and/or the autonomous vehicle, e.g., for the autonomous vehicle to carry out to traverse the exception condition in accordance with the higher-level discrete option, partial, and/or upper-hierarchy command(s). In some embodiments, for example, a remedial option may state “return to maintenance facility,” which may include, define, and/or invoke the individual/middle-hierarchy instructions to (i) find a route to the maintenance facility (which may, for example, comprises an additional or lower-hierarchy set of individual instructions such as (a) identify a current location, (b) identify a destination location, (c) compute a route between the two locations, etc.), (ii) begin driving along route to maintenance facility, (iii) find an open bay at maintenance facility, and (iv) drive into open bay at maintenance facility.

The list of discrete remedial options may be displayed on a user interface to an operator for the operator to choose the most appropriate option for the autonomous vehicle to undertake, at 910. In some embodiments, there may be multiple operators having different skills and/or levels of training and expertise (e.g., training in proper full remote operation of the particular autonomous vehicle). In some embodiments, the remote operator safety system may execute operator logic to route an exception condition to an operator having the skill set and/or training and expertise in that exception condition and/or with that particular autonomous vehicle, route, location, etc. In some embodiments, the operator may select the most appropriate option using the user interface, and data indicative of the selection may be received, e.g., by the remote operator safety station at 912. In some embodiments, the remote operator safety station may then retrieve the instructions associated with the chosen remedial option by the operator at 914, and may send those instructions to the autonomous vehicle via the network at 916. In some embodiments, the remote operator safety station may then engage the next exception condition the order of priority, at 918.

Fewer or more procedures and/or elements 902, 904, 906, 908, 910, 912, 914, 916, 918 and/or various configurations of the depicted procedures and/or elements 902, 904, 906, 908, 910, 912, 914, 916, 918 may be included in the method 900 without deviating from the scope of embodiments described herein. In some embodiments, the method 900 (and/or portions thereof) may comprise and/or be implemented or conducted by an autonomous vehicle exception handling program, system, and/or platform programmed and/or otherwise configured to execute, conduct, and/or facilitate various methods, procedures, and/or elements, such as the method 300 of FIG. 3, and/or portions or combinations thereof.

### IX. Controller in Use with the Remote Operator Safety Station

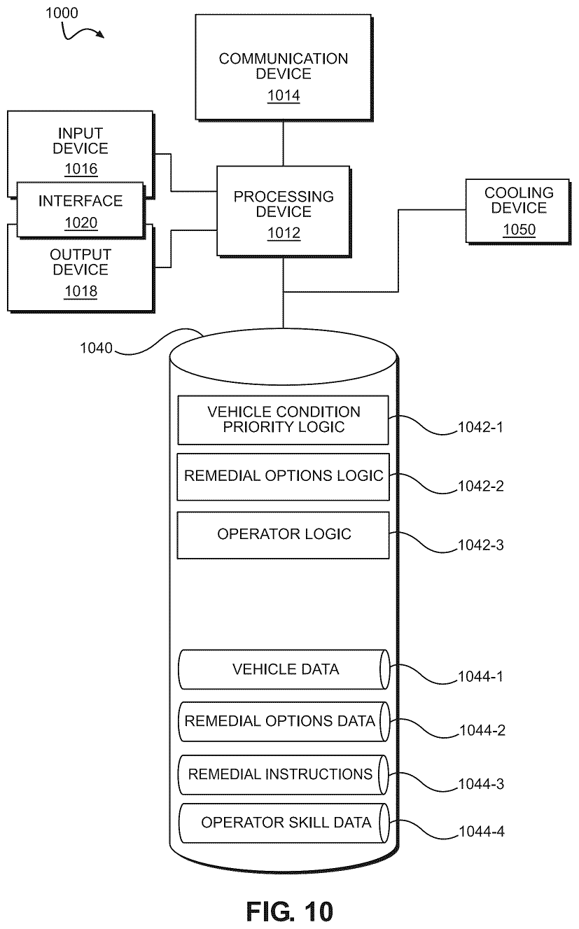

Turning to FIG. 10, a block diagram of an apparatus 1010 according to some embodiments is shown. In some embodiments, the apparatus 1010 may be similar in configuration and/or functionality to one or more of the controller 110-1 of FIG. 1 herein, and/or in conjunction with the remote operator safety station 106 and/or of FIG. 1 herein. In some embodiments, the apparatus 1010 may, for example, execute, process, facilitate, and/or otherwise be associated with the methods/algorithms 300, 900 of FIG. 3 and/or FIG. 9 herein, and/or portions or combinations thereof. In some embodiments, the apparatus 1010 may comprise a processing device 1012, a communication device 1014, an input device 1016, an output device 1018, an interface 1020, a memory device 1040 (storing various programs and/or instructions 1042 and data 1044), and/or a cooling device 1050.

According to some embodiments, the processor 1012 may be or include any type, quantity, and/or configuration of processor that is or becomes known. The processor 1012 may comprise, for example, an Intel® IXP 2800 network processor or an Intel® XEON™ Processor coupled with an Intel® E7501 chipset. In some embodiments, the processor 1012 may comprise multiple interconnected processors, microprocessors, and/or micro-engines. According to some embodiments, the processor 1012 (and/or the apparatus 1010 and/or other components thereof) may be supplied power via a power supply (not shown), such as a battery, an AC source, a DC source, an AC/DC adapter, solar cells, and/or an inertial generator. In the case that the apparatus 1010 comprises a server, such as a blade server, necessary power may be supplied via a standard AC outlet, power strip, surge protector, and/or UPS device.

In some embodiments, the communication device 1014 may comprise any type or configuration of communication device that is or becomes known or practicable. The communication device 1014 may, for example, comprise a NIC, a telephonic device, a cellular network device, a router, a hub, a modem, and/or a communications port or cable. In some embodiments, the communication device 1014 may be coupled to receive user input data, e.g., from a user device (not shown in FIG. 10). The communication device 1014 may, for example, comprise a Bluetooth® Low Energy (BLE) and/or RF receiver device and/or a camera or other imaging device that acquires data from a user (not separately depicted in FIG. 10) and/or a transmitter device that provides the data to a remote server and/or server or communications layer (also not separately shown in FIG. 10). According to some embodiments, the communication device 1014 may also or alternatively be coupled to the processor 1012. In some embodiments, the communication device 1014 may comprise an IR, RF, Bluetooth™, NFC, and/or Wi-Fi® network device coupled to facilitate communications between the processor 1012 and another device (such as a remote user device, not separately shown in FIG. 10).

In some embodiments, the input device 1016 and/or the output device 1018 are communicatively coupled to the processor 1012 (e.g., via wired and/or wireless connections and/or pathways) and they may generally comprise any types or configurations of input and output components and/or devices that are or become known, respectively. The input device 1016 may comprise, for example, a keyboard that allows an operator of the apparatus 1010 to interface with the apparatus 1010 (e.g., by an operator to input an objective for the autonomous vehicle, as described herein). In some embodiments, the input device 1016 may comprise a sensor, such as a camera, sound, light, distance ranging, and/or proximity sensor, configured to measure parameter values and report measured values via signals to the apparatus 1010 and/or the processor 1012. The output device 1018 may, according to some embodiments, comprise a display screen and/or other practicable output component and/or device. The output device 1018 may, for example, provide an interface (such as the interface 1020) via which operating instructions, objective data, and/or other operating parameters to a user (e.g., via a website and/or mobile device application). According to some embodiments, the input device 1016 and/or the output device 1018 may comprise and/or be embodied in a single device, such as a touch-screen monitor or a personal handheld device.

The memory device 1040 may comprise any appropriate information storage device that is or becomes known or available, including but not limited to, units and/or combinations of magnetic storage devices (e.g., a hard disk drive), optical storage devices, and/or semiconductor memory devices, such as RAM devices, ROM devices, SDR-RAM, DDR-RAM, and/or PROM. The memory device 1040 may, according to some embodiments, store one or more of vehicle condition priority logic 1042-1, remedial options logic 1042-2, operator logic 1042-3, vehicle data 1044-1, remedial options data 1044-2, remedial instructions 1044-3, and/or operator skill data 1044-4. In some embodiments, the vehicle condition priority logic 1042-1, remedial options logic 1042-2, operator logic 1042-3, vehicle data 1044-1, remedial options data 1044-2, remedial instructions 1044-3, and/or operator skill data 1044-4 may be utilized by the processor 1012 to analyze input received by the communication device 1014 from the sensor(s) and provide output information via the output device 1018 and/or the communication device 1014.

According to some embodiments, the vehicle condition priority logic 1042-1 may be operable to cause the processor 1012 to process the vehicle data 1044-1, remedial options data 1044-2, remedial instructions 1044-3, and/or operator skill data 1044-4 in accordance with embodiments as described herein. Vehicle data 1044-1, route data 1044-2, rules of road data 1044-3, and/or road condition data 1044-4 received via the input device 1016 and/or the communication device 1014 may, for example, be analyzed, sorted, filtered, decoded, decompressed, ranked, scored, plotted, and/or otherwise processed by the processor 1012 in accordance with the vehicle condition priority logic 1042-1. In some embodiments, vehicle data 1044-1, remedial options data 1044-2, remedial instructions 1044-3, and/or operator skill data 1044-4 may be fed by the processor 1012 through one or more mathematical and/or statistical formulas and/or models in accordance with the vehicle condition priority logic 1042-1 to merge transcribe, decode, convert, and/or otherwise process and prioritize reported exception conditions from autonomous vehicles, as described herein.

In some embodiments, the remedial options logic 1042-2 may be operable to cause the processor 1012 to process the vehicle data 1044-1, remedial options data 1044-2, remedial instructions 1044-3, and/or operator skill data 1044-4 in accordance with embodiments as described herein. Vehicle data 1044-1, route data 1044-2, rules of road data 1044-3, and/or road condition data 1044-4 received via the input device 1016 and/or the communication device 1014 may, for example, be analyzed, sorted, filtered, decoded, decompressed, ranked, scored, plotted, and/or otherwise processed by the processor 1012 in accordance with the remedial options logic 1042-2. In some embodiments, vehicle data 1044-1, remedial options data 1044-2, remedial instructions 1044-3, and/or operator skill data 1044-4 may be fed by the processor 1012 through one or more mathematical and/or statistical formulas and/or models in accordance with the remedial options logic 1042-2 to identify, classify, and/or otherwise compute a set a discrete remedial options to be presented to an operator and/or associate some or all of the presented discrete remedial option with a set of instructions to be communicated with an autonomous vehicle, as described herein.

According to some embodiments, the operator logic 1042-3 may be operable to cause the processor 1012 to process the vehicle data 1044-1, remedial options data 1044-2, remedial instructions 1044-3, and/or operator skill data 1044-4 in accordance with embodiments as described herein. Vehicle data 1044-1, route data 1044-2, rules of road data 1044-3, and/or road condition data 1044-4 received via the input device 1016 and/or the communication device 1014 may, for example, be analyzed, sorted, filtered, decoded, decompressed, ranked, scored, plotted, and/or otherwise processed by the processor 1012 in accordance with the operator logic 1042-3. In some embodiments, vehicle data 1044-1, remedial options data 1044-2, remedial instructions 1044-3, and/or operator skill data 1044-4 may be fed by the processor 1012 through one or more mathematical and/or statistical formulas and/or models in accordance with the operator logic 1042-3 to identify, classify, and/or otherwise compute which of a plurality of operators is most appropriate (e.g., based on experience, skill level, and/or training) for a given exception condition, as described herein.

According to some embodiments, the apparatus 1010 may comprise the cooling device 1050. According to some embodiments, the cooling device 1050 may be coupled (physically, thermally, and/or electrically) to the processor 1012 and/or to the memory device 1040. The cooling device 1050 may, for example, comprise a fan, heat sink, heat pipe, radiator, cold plate, and/or other cooling component or device or combinations thereof, configured to remove heat from portions or components of the apparatus 1010. Any or all of the exemplary instructions and data types described herein and other practicable types of data may be stored in any number, type, and/or configuration of memory devices that is or becomes known. The memory device 1040 may, for example, comprise one or more data tables or files, databases, table spaces, registers, and/or other storage structures. In some embodiments, multiple databases and/or storage structures (and/or multiple memory devices 1040) may be utilized to store information associated with the apparatus 1010. According to some embodiments, the memory device 1040 may be incorporated into and/or otherwise coupled to the apparatus 1010 (e.g., as shown) or may simply be accessible to the apparatus 1010 (e.g., externally located and/or situated).

Fewer or more procedures, components, and/or elements 1012, 1014, 1016, 1018, 1020, 1040, 1042, 1044, 1050 and/or various configurations of the depicted procedures, components, and/or elements 1012, 1014, 1016, 1018, 1020, 1040, 1042, 1044, 1050 may be included in the apparatus 1010 without deviating from the scope of embodiments described herein. In some embodiments, the apparatus 1010 (and/or portions thereof) may comprise an autonomous vehicle exception handling program, system, and/or platform programmed and/or otherwise configured to execute, conduct, and/or facilitate various methods, procedures, and/or elements, such as the methods 300, 900 of FIG. 3 and/or FIG. 9 herein, and/or portions or combinations thereof.

### X. Rules of Interpretation

Throughout the description herein and unless otherwise specified, the following terms may include and/or encompass the example meanings provided. These terms and illustrative example meanings are provided to clarify the language selected to describe embodiments both in the specification and in the appended points of focus, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device.

As used herein, the term “network component” may refer to a user or network device, or a component, piece, portion, or combination of user or network devices. Examples of network components may include a SRAM device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like. The term “computing” as utilized herein may generally refer to any number, sequence, and/or type of electronic processing activities performed by an electronic device, such as, but not limited to looking up (e.g., accessing a lookup table or array), calculating (e.g., utilizing multiple numeric values in accordance with a mathematic formula), deriving, and/or defining.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media, such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as ultra-wideband (UWB) radio, Bluetooth™, Wi-Fi, TDMA, CDMA, 3G, 4G, 4G LTE, 5G, etc.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium, such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

### XI. Additional Embodiments

In some embodiments, a remote operator system for control of autonomous vehicles may comprise: (i) a plurality of autonomously controlled vehicles, each of the autonomously controlled vehicles being controlled by an execution, by a processing device, of a local AI rule set stored in a local memory, and in response to data captured by one or more sensors of the autonomously controlled vehicles; and (ii) a remote operator safety station in communication with each of the autonomously controlled vehicles of the plurality of autonomously controlled vehicles, and comprising a user interface, one or more processors, and at least one memory device storing a centralized/remote AI rule set and/or instructions that, when executed by the one or more processors, results in: (a) receiving (e.g., via a wireless communication system) a signal from one of the plurality of autonomous vehicles indicating and/or descriptive of an exception that has been identified by an execution of the local Al rule set for the vehicle; (b) verifying, by an execution of the centralized/remote Al rule set, that the exception condition (1) can be handled automatically or (2) cannot be handled automatically; (c) in the case that the exception condition can be handled automatically, computing a resolution to the exception condition and sending one or more commands defining the resolution to the one of the plurality of autonomous vehicles; (d) in the case that the exception condition cannot be handled automatically, identifying (e.g., by querying stored data utilizing data descriptive of the exception condition) one or more discrete remedial options (e.g., partial control and/or upper-hierarchy commands); (e) outputting (e.g., via a user interface and/or in response to the verifying and/or identifying) at least one user input element representing the one or more discrete remedial options for selection by the human operator; (f) receiving (e.g., via the user interface and/or the at least one user input element) a selection of at least one of the one or more discrete remedial options; and (g) transmitting (e.g., via the wireless communication system) data descriptive of the selected at least one remedial option to the one of the plurality of autonomous vehicles.

According to some embodiments, the one or more discrete remedial options may be predefined as consisting of a plurality of individual remedial commands and/or actions (e.g., middle-hierarchy and/or lower-hierarchy commands). In some embodiments, the definitions of the one or more discrete remedial options and corresponding plurality of individual remedial commands and/or actions may be stored in the at least one memory device of the remote operator safety station and/or one or more of the local memories of the plurality of autonomous vehicles.

In such a manner, for example, the centralized/remote AI rule set may be implemented to filter, rank, score, and/or otherwise process the incoming exception data defined by the local AI rule sets, thereby decreasing the workload of the remote operators. The centralized/remote AI rule set may be more complex and/or differently programmed and/or trained than the local AI rule sets, for example, such that more complex decisions and/or determinations may be resolved by the centralized/remote AI rule set. In the case that even the centralized/remote AI rule set cannot automatically resolve an exception, the remote user/operator may be provided with the one or more discrete remedial options that may be selected and implemented without the user/operator needing to know or understand the underlying individual remedial commands and/or actions that are required to be implemented to carry out the objective(s) of the one or more discrete remedial options.

### XII. Conclusion

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicant intends to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the present disclosure.

What is claimed is:

1. A remote operator safety station comprising:
a communication system configured to communicate with a plurality of autonomous vehicles and receive a plurality of parameters related to operation of one or more of the plurality of autonomous vehicles, the plurality of parameters comprising at least one of a position, a speed, a direction, an objective, a visual representation of the vehicle's surroundings, an audible representation of the vehicle's surroundings, an exception condition, and a priority of the exception condition;
a user station comprising a user interface configured to receive one or more inputs from a human operator and to display one or more of the plurality of parameters of at least one of the plurality of autonomous vehicles;
one or more processors operatively coupled to the communication system and the user station; and
at least one memory storing (i) centralized AI rules, and (ii) computer-readable instructions that, when executed by the one or more processors, cause the one or more processors to:
receive, via the communication system, a signal from one of the plurality of autonomous vehicles indicating an exception condition requiring human input;
verifying, by an execution of the centralized AI rules, that the exception condition cannot be handled automatically;
identifying, by querying stored data utilizing data descriptive of the exception condition, one or more discrete remedial options;
display, via the user interface and in response to the verifying, at least one user input element representing the one or more discrete remedial options for selection by the human operator based on the exception condition, wherein each of the discrete remedial options comprises at least one pre-defined remedial instruction;
receive, via the user interface, a selection of at least one of the one or more discrete remedial options; and
send, via the communication system, the at least one remedial instruction associated with the received selection to the one of the plurality of autonomous vehicles to at least partly control operation thereof and eliminate the exception condition.

2. The remote operator safety station of claim 1, wherein each of the plurality of autonomous vehicles comprises an onboard communication system and an onboard autonomous operation stack, the onboard autonomous operation stack comprising:
one or more processors operatively coupled to the onboard communication system and the onboard autonomous operation stack; and
at least one memory storing computer-readable instructions that, when executed by the one or more processors, cause the one or more processors to:
receive, via the onboard communication system, an objective for at least one of the plurality of autonomous vehicles;
determine a set of objective instructions for the at least one of the plurality of autonomous vehicles to achieve the received objective;
sense, via onboard sensors, a condition preventing at least one of the determined set of objective instructions from being carried out, and determine whether the condition is an exception condition that requires intervention by a human operator;
send, via the onboard communication system, the exception condition to the user station.

3. The remote operator safety station of claim 2, wherein:
the signal received from one of the plurality of autonomous vehicles is a first signal; and
wherein the instructions, when executed by the one or more processors, further cause the one or more processors to:
receive a second signal from a second of the plurality of autonomous vehicles; and
determine, based on the exception condition priority, whether the discrete remedial options of the first exception condition or discrete remedial options of the second exception condition are displayed via the user interface.

4. The remote operator safety station of claim 1, wherein the user interface comprises a touch screen interface.

5. The remote operator safety station of claim 4, wherein the user interface further comprises at least one of a steering control, a braking control, and an acceleration control.

6. The remote operator safety station of claim 5, wherein:
the user station further comprises a dead-man switch configured to deactivate the user interface when the dead-man switch is not activated;
the discrete remedial option selection is a manual override option.

7. The remote operator safety station of claim 6, wherein the exception condition is related to an adverse visual condition.

8. The remote operator safety station of claim 1, wherein the received selection is sent to a second of the plurality of autonomous vehicles such that the second of the plurality of autonomous vehicles that encounters the exception condition automatically uses the instruction associated with the received selection to eliminate the exception condition.

9. The remote operator safety station of claim 1, wherein the user station is a first user station configured for use by a first human operator having a first set of skill and knowledge, and further comprising a second user station configured for use by a second human operator having a second set of skill and knowledge;
and wherein the at least one memory storing computer-readable instructions cause the one or more processors to determine, based on the first and second set of skill and knowledge of the first and second human operator, to display on the first user station the one or more discrete remedial options.

10. The remote operator safety station of claim 1, further comprising a second user station and wherein the instructions, when executed by the one or more processors, further cause the one or more processors to:
receive a signal from the user station to switch control of at least one of the plurality of autonomous vehicles to the second user station,
display an option on a user interface of the second user station to accept control of the at least one of the plurality of autonomous vehicles on the second user station;
receive a signal on the user interface of the second user station that control of the at least one of the plurality of autonomous vehicles is accepted, and
send a signal to the user station that control of the at least one of the plurality of autonomous vehicles is confirmed switched to the second user station.

11. A remote operator system for control of autonomous vehicles, comprising:
a plurality of autonomously controlled vehicles, each of the autonomously controlled vehicles having an onboard communication system, a steering control, a braking control, an acceleration control, a plurality of sensors, and an onboard autonomous operation stack coupled with each of the onboard communication system, the steering control, the braking control, the acceleration control, and the plurality of sensors;
a communication system configured to communicate with the plurality of autonomous vehicles and receive a plurality of parameters related to operation of one or more of the plurality of autonomous vehicles, the plurality of parameters including an exception condition and a priority of the exception condition, the plurality of parameters further comprising at least one of a position, a speed, a direction, an objective, a visual representation of the vehicle's surroundings, and an audible representation of the vehicle's surroundings;
a user station coupled to the communication system and comprising a user interface, one or more processors, and at least one memory storing computer-readable instructions, the user station configured to receive one or more inputs from a human operator and to display one or more of the plurality of parameters of at least one of the plurality of autonomous vehicles, and wherein an execution of the instructions by the one or more processors causes the user station to:
receive, via the communication system, a signal from one of the plurality of autonomous vehicles indicating an exception condition requiring human input;
display, via the user interface, one or more discrete remedial options for selection by the human operator based on the exception condition, wherein each of the discrete remedial options comprises at least one remedial instruction;
receive, via the user interface, a selection of at least one of the one or more discrete remedial options; and
send, via the communication system, the at least one remedial instruction associated with the received selection to the one of the plurality of autonomous vehicles to at least partly control operation thereof and eliminate the exception condition.

12. The remote operator system of claim 11, wherein the plurality of sensors includes at least one of a visual camera, an infrared imaging device, a compass, an inclinometer, a Global Positioning System (GPS), an inertial measurement unit (IMU), an odometer, a speedometer, a microphone, ultrasonic sensor, radio detection and ranging (RADAR) sensor, and a laser detection and ranging (LIDAR) sensor.

13. The remote operator safety station of claim 11, wherein the user station is a first user station and further comprising a second user station and wherein the second user station:
receives a signal from the first user station to switch control of at least one of the plurality of autonomous vehicles to the second user station,
displays an option on a user interface of the second user station to accept control of the at least one of the plurality of autonomous vehicles on the second user station;
receives a signal on the user interface of the second user station that control of the at least one of the plurality of autonomous vehicles is accepted, and
sends a signal to the first user station that control of the at least one of the plurality of autonomous vehicles is confirmed switched to the second user station.

14. The remote operator safety station of claim 11, wherein:
the signal received from one of the plurality of autonomous vehicles is a first signal; and
wherein the instructions, when executed by the one or more processors, further cause the user station to:
receive a second signal from a second of the plurality of autonomous vehicles; and
cause the one or more processors to determine, based on the exception condition priority, whether the discrete remedial options of the first exception condition or the discrete remedial options of the second exception condition are displayed via the user interface.

15. A method of remotely operating a plurality of autonomous vehicles comprising:
receiving, at a safety station having a processor and a memory and via a communication system coupled to the safety station, a signal from one of a plurality of autonomous vehicles performing instructions to achieve an objective, the signal indicating an exception condition preventing the one of the plurality of autonomous vehicles from performing an instruction and requiring human input to overcome the exception condition;
displaying, via a user interface coupled to the safety station, one or more discrete remedial options for selection by a human operator based on the exception condition, wherein each of the discrete remedial options comprises at least one remedial instruction;
receiving, via the user interface, a selection of at least one of the one or more discrete remedial options; and
sending, via the communication system, the at least one remedial instruction associated with the received selection to the one of the plurality of autonomous vehicles to at least partly control operation thereof;
performing the at least one remedial instruction associated with the received selection by manipulating at least one of a steering control, a braking control, and an acceleration control on the one of the plurality of autonomous vehicles.

16. The method of claim 1511, wherein the signal received from the one of the plurality of autonomous vehicles is a first signal of a first exception condition having a first priority, and further comprising:
receiving, at the safety station, a second signal from a second of a plurality of autonomous vehicles performing instructions to achieve an objective, a second signal indicating a second exception condition preventing the second of the plurality of autonomous vehicles from performing an instruction and requiring human input to overcome the second exception condition, the second exception condition having a second priority;
determining, based on a comparison of the first priority and the second priority, which of the discrete remedial options of the first exception condition and the discrete remedial options of the second exception condition are displayed via the user interface.
